(19) United States
(12) Patent Application Publication
(10) Pub. No.: US 2024/0428413 A1
(43) Pub. Date: Dec. 26, 2024

(54) SYSTEMS AND METHODS FOR MOTION CORRECTION FOR MEDICAL IMAGES

(71) Applicant: SHANGHAI UNITED IMAGING HEALTHCARE CO., LTD., Shanghai (CN)

(72) Inventors: Peng WANG, Shanghai (CN); Jiao TIAN, Shanghai (CN)

(73) Assignee: SHANGHAI UNITED IMAGING HEALTHCARE CO., LTD., Shanghai (CN)

(21) Appl. No.: 18/747,423

(22) Filed: Jun. 18, 2024

Related U.S. Application Data
(63) Continuation of application No. PCT/CN2021/143673, filed on Dec. 31, 2021.

(51) Int. Cl. G06T 7/00; G06T 11/00

(52) U.S. Cl. CPC G06T 7/0014; G06T 11/00; G06T 2207/10081; G06T 2207/20081; G06T 2207/30048

(57) ABSTRACT

The present disclosure is related to systems and methods for motion correction. The method includes obtaining an original image including a motion artifact. The method includes obtaining a target motion correction model. The method includes generating a target image by removing the motion artifact from the original image using the target motion correction model.

### CROSS-REFERENCE TO RELATED APPLICATIONS

This application is a Continuation of International Application No. PCT/CN2021/143673, filed on Dec. 31, 2021, and the contents of which are hereby incorporated by reference.

### TECHNICAL FIELD

The present disclosure generally relates to image processing, and more particularly, relates to systems and methods for motion correction for a medical image.

### BACKGROUND

Medical imaging techniques including, e.g., magnetic resonance imaging (MRI), positron emission tomography (PET), computed tomography (CT), single-photon emission computed tomography (SPECT), etc., are widely used in clinical diagnosis and/or treatment. An image of a subject taken by an imaging system, such as a CT system, may have artifacts due to a variety of factors, such as a motion of the subject. For example, motion artifacts often exist in images of coronary arteries of the heart of a patient since the heart beats ceaselessly. Thus, it is desirable to provide a system and method for correcting motion artifacts in medical images effectively and accurately.

### SUMMARY

According to an aspect of the present disclosure, a method may be implemented on a computing device having one or more processors and one or more storage devices. The method may include obtaining an original image including a motion artifact. The method may include obtaining a target motion correction model. The method may include generating a target image by removing the motion artifact from the original image using the target motion correction model.

In some embodiments, the original image may be a three-dimensional (3D) image including a plurality of 2D layers. The method may include, for each 2D layer of the plurality of 2D layers, obtaining a plurality of reference layers adjacent to the 2D layer. The method may include generating a corrected 2D layer by inputting the 2D layer and the plurality of reference layers into the target motion correction model. The method may include generating the target image by combining a plurality of corrected 2D layers.

In some embodiments, the method may include obtaining a plurality of training samples each of which including a sample image and a reference image. The sample image may include a motion artifact and the reference image may be with substantial removal of the motion artifact. The method may include determining the target motion correction model by training, based on the plurality of training samples according to a combined loss function, a preliminary model. The combined loss function may include at least a local loss function, a dice loss function, and a global loss function.

In some embodiments, the local loss function may be associated with a coronary artery.

In some embodiments, the target motion correction model may be obtained according to a process. The process may include obtaining a plurality of preliminary models of different structures. The process may include obtaining a plurality of training samples. The plurality of training samples may include at least one first training sample and at least one second training sample. Each training sample may include a first sample image and a first reference image. The process may include generating the target motion correction model by training each preliminary model of the plurality of preliminary models using the plurality of training samples.

In some embodiments, the method may include, for each first training sample, obtaining the first sample image including a motion artifact. The method may include obtaining the first reference image by removing the motion artifact from the first sample image.

In some embodiments, the method may include, for each second training sample, obtaining the first reference image without a motion artifact. The method may include obtaining the first sample image by adding a simulated motion artifact to the first reference image.

In some embodiments, the method may include obtaining a plurality of candidate motion correction models by training the plurality of preliminary models using the plurality of training samples. The method may include selecting the target motion correction model from the plurality of candidate motion correction models based on a plurality of values of a first loss function corresponding to the plurality of candidate motion correction models.

In some embodiments, for the each preliminary model, training the preliminary model according to an iterative operation may include one or more iterations. In at least one of the one or more iterations, the method may include obtaining an updated preliminary model generated in a previous iteration. The method may include, for each training sample, generating a first sample intermediate image by inputting the first sample image into the updated preliminary model. The method may include determining a value of a second loss function based on the first sample intermediate image and the first reference image. The method may include updating the updated preliminary model based on the value of the second loss function. The method may include designating the updated preliminary model as a candidate motion correction model based on the value of the second loss function.

In some embodiments, the method may include obtaining at least one testing sample. The at least one testing sample may include a second sample image and a second reference image. The method may include, for each candidate motion correction model, generating a second sample intermediate image by inputting the second sample image into the candidate motion correction model. The method may include determining a value of the first loss function based on the second sample intermediate image and the second reference image. The method may include selecting the target motion correction model from the plurality of candidate motion correction models based on the plurality of values of the first loss function corresponding to the plurality of candidate motion correction models.

In some embodiments, the method may include obtaining at least one verifying sample. The at least one verifying sample may include a third sample image and a third reference image. The method may include verifying the target motion correction model using the at least one verifying sample.

In some embodiments, the method may include generating a third sample intermediate image by inputting the third sample image into the target motion correction model. The method may include determining a value of a third loss function based on the third sample intermediate image and the third reference image. The method may include, in response to determining that the value of the third loss function satisfies a condition, determining the target motion correction model as a verified target motion correction model.

In some embodiments, the original image may be a computed tomography (CT) image of a heart.

According to another aspect of the present disclosure, a system may include at least one storage device storing a set of instructions, and at least one processor in communication with the at least one storage device. When executing the stored set of instructions, the at least one processor may cause the system to perform a method. The method may include obtaining an original image including a motion artifact. The method may include obtaining a target motion correction model. The method may include generating a target image by removing the motion artifact from the original image using the target motion correction model.

According to another aspect of the present disclosure, a non-transitory computer readable medium may include at least one set of instructions. When executed by at least one processor of a computing device, the at least one set of instructions may cause the at least one processor to effectuate a method. The method may include obtaining an original image including a motion artifact. The method may include obtaining a target motion correction model. The method may include generating a target image by removing the motion artifact from the original image using the target motion correction model.

According to another aspect of the present disclosure, a method may be implemented on a computing device having one or more processors and one or more storage devices. The method may include obtaining a plurality of preliminary models of different structures. The method may include obtaining a plurality of training samples. The plurality of training samples may include at least one first training sample and at least one second training sample. Each training sample may include a first sample image and a first reference image. The method may include generating a target motion correction model by training each preliminary model of the plurality of preliminary models using the plurality of training samples.

In some embodiments, the at least one first training sample may be associated with at least one image generated by an imaging device. The at least one second training sample may be associated with at least one simulated image.

In some embodiments, the method may include obtaining a plurality of candidate motion correction models by training the plurality of preliminary models using the plurality of training samples. The method may include selecting the target motion correction model from the plurality of candidate motion correction models based on a plurality of values of a first loss function corresponding to the plurality of candidate motion correction models.

In some embodiments, for the each preliminary model, training the preliminary model according to an iterative operation may include one or more iterations. In at least one of the one or more iterations, the method may include obtaining an updated preliminary model generated in a previous iteration. The method may include, for each training sample, generating a first sample intermediate image by inputting the first sample image into the updated preliminary model. The method may include determining a value of a second loss function based on the first sample intermediate image and the first reference image. The method may include updating the updated preliminary model based on the value of the second loss function. The method may include designating the updated preliminary model as a candidate motion correction model based on the value of the second loss function. The second loss function may be a combined loss function including at least a local loss function, a dice loss function, and a global loss function.

In some embodiments, the method may include extracting a centerline of a coronary artery from the first reference image. The method may include determining a mask by performing an expansion operation on the centerline. The method may include determining a value of the local loss function based on the mask, the first sample intermediate image, and the first reference image.

In some embodiments, the method may include determining, in the first sample intermediate image, a first local region corresponding to the coronary artery based on the mask and the first sample intermediate image. The method may include determining, in the first reference image, a second local region corresponding to the coronary artery based on the mask and the first reference image. The method may include determining the value of the local loss function based on a difference between the first local region and the second local region.

In some embodiments, the method may include segmenting a first coronary artery from the first sample intermediate image. The method may include segmenting a second coronary artery from the first reference image. The method may include determining a value of the dice related loss function based on the first coronary artery and the second coronary artery.

In some embodiments, the method may include determining a value of the global loss function based on the first sample intermediate image and the first reference image.

In some embodiments, the method may include determining a value of the combined loss function by a weighted sum of a value of the local loss function, a value of the dice related loss function, and a value of the global loss function.

In some embodiments, a first significance of the local loss function may be higher than a second significance of the dice related loss function. The second significance of the dice related loss function may be higher than a third significance of the global loss function.

In some embodiments, the method may include performing a preprocessing operation on the value of the local loss function, the value of the dice related loss function, and the value of the global loss function respectively, such that the preprocessed value of the local loss function, the preprocessed value of the dice function, and the preprocessed value of the global loss function are in a same order of magnitude. The method may include determining the value of the combined loss function by a weighted sum of the preprocessed value of the local loss function, the preprocessed value of the dice related loss function, and the preprocessed value of the global loss function.

In some embodiments, the preprocessing operation may include enlarging at least one of the value of the local loss function or the value of the dice related loss.

In some embodiments, the method may include obtaining a plurality of corrected images of an original image. The method may include obtaining a reference image corresponding to the initial image. The method may include determining the combined loss function based on the plurality of corrected images and the reference image.

In some embodiments, the method may include determining a reference rank result by ranking the plurality of corrected images. The method may include obtaining an initial loss function. The method may include determining an evaluated rank result by ranking, based on the initial loss function and the reference image, the plurality of corrected images. The method may include determining the combined loss function by adjusting the initial loss function until an updated evaluated rank result substantially coincides with the reference rank result.

In some embodiments, the method may include obtaining at least one testing sample. The at least one testing sample may include a second sample image and a second reference image. The method may include, for each candidate motion correction model, generating a second sample intermediate image by inputting the second sample image into the candidate motion correction model. The method may include determining a value of the first loss function based on the second sample intermediate image and the second reference image. The method may include selecting the target motion correction model from the plurality of candidate motion correction models based on the plurality of values of the first loss function corresponding to the plurality of candidate motion correction models.

In some embodiments, the method may include obtaining at least one verifying sample. The at least one verifying sample may include a third sample image and a third reference image. The method may include verifying the target motion correction model using the at least one verifying sample.

In some embodiments, the method may include generating a third sample intermediate image by inputting the third sample image into the target motion correction model. The method may include determining a value of a third loss function based on the third sample intermediate image and the third reference image. The method may include in response to determining that the value of the third loss function satisfies a condition, determining the target motion correction model as a verified target motion correction model.

According to another aspect of the present disclosure, a system may include at least one storage device storing a set of instructions, and at least one processor in communication with the at least one storage device. When executing the stored set of instructions, the at least one processor may cause the system to perform a method. The method may include obtaining a plurality of preliminary models of different structures. The method may include obtaining a plurality of training samples. The plurality of training samples may include at least one first training sample and at least one second training sample. Each training sample may include a first sample image and a first reference image. The method may include generating a target motion correction model by training each preliminary model of the plurality of preliminary models using the plurality of training samples.

According to another aspect of the present disclosure, a non-transitory computer readable medium may include at least one set of instructions. When executed by at least one processor of a computing device, the at least one set of instructions may cause the at least one processor to effectuate a method. The method may include obtaining a plurality of preliminary models of different structures. The method may include obtaining a plurality of training samples. The plurality of training samples may include at least one first training sample and at least one second training sample. Each training sample may include a first sample image and a first reference image. The method may include generating a target motion correction model by training each preliminary model of the plurality of preliminary models using the plurality of training samples.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary medical system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device according to some embodiments of the present disclosure;

FIGS. 4A and 4B are block diagrams illustrating exemplary processing devices according to some embodiments of the present disclosure;

FIG. 5 is a flowchart illustrating an exemplary process for generating a target image according to some embodiments of the present disclosure;

FIG. 6 is a flowchart illustrating an exemplary process for generating a target motion correction model according to some embodiments of the present disclosure;

FIG. 7 is a flowchart illustrating an exemplary process for generating a candidate motion correction model according to some embodiments of the present disclosure;

FIG. 8 is a flowchart illustrating an exemplary process for determining a combined loss function according to some embodiments of the present disclosure; and

FIG. 9 is a flowchart illustrating an exemplary process for evaluating a correction effect of a correction algorithm according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is to describe particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the terms “system,” “unit,” “module,” and/or “block” used herein are one method to distinguish different components, elements, parts, sections, or assemblies of different levels in ascending order. However, the terms may be displaced by another expression if they achieve the same purpose.

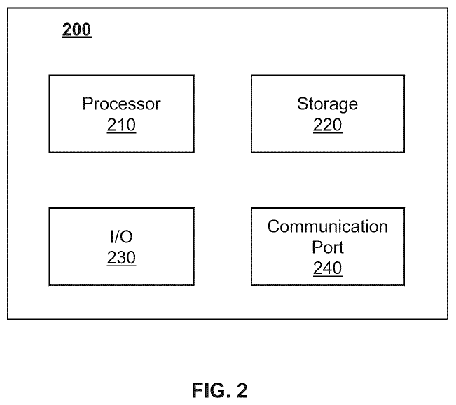

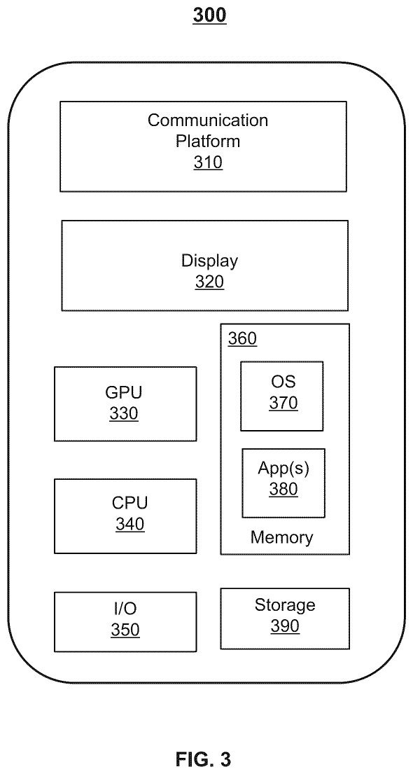

Generally, the words “module,” “unit,” or “block,” as used herein, refer to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., the processor 210 illustrated in FIG. 2 and/or the central processing unit (CPU) 340 illustrated FIG. 3) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may apply to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Provided herein are medical systems and methods for non-invasive biomedical imaging/treatment, such as for disease diagnostic, disease therapy, or research purposes. In some embodiments, the medical system may include a single modality system and/or a multi-modality system. The term “modality” used herein broadly refers to an imaging or treatment method or technology that gathers, generates, processes, and/or analyzes imaging information of a subject or treatments the subject. The single modality system may include, for example, an ultrasound imaging system, an X-ray imaging system (e.g., a digital radiography (DR) system, a computed radiography (CR) system), a computed tomography (CT) system, a magnetic resonance imaging (MRI) system, an ultrasonography system, a single photon emission computed tomography (SPECT), a positron emission tomography (PET) system, an optical coherence tomography (OCT) imaging system, an ultrasound (US) imaging system, an intravascular ultrasound (IVUS) imaging system, a near-infrared spectroscopy (NIRS) imaging system, a digital subtraction angiography (DSA) system, or the like, or any combination thereof. The multi-modality system may include, for example, an X-ray imaging-magnetic resonance imaging (X-ray-MRI) system, a positron emission tomography-X-ray imaging (PET-X-ray) system, a single photon emission computed tomography-magnetic resonance imaging (SPECT-MRI) system, a positron emission tomography-computed tomography (PET-CT) system, a C-arm system, a positron emission tomography-magnetic resonance imaging (PET-MR) system, a digital subtraction angiography-magnetic resonance imaging (DSA-MRI) system, etc. In some embodiments, the medical system may include a treatment system. The treatment system may include a treatment plan system (TPS), an image-guided radiotherapy (IGRT) system, etc. The image-guided radiotherapy (IGRT) may include a treatment device and an imaging device. The treatment device may include a linear accelerator, a cyclotron, a synchrotron, etc., configured to perform radiotherapy on a subject. The treatment device may include an accelerator of species of particles including, for example, photons, electrons, protons, or heavy ions. The imaging device may include an MRI scanner, a CT scanner, etc. It should be noted that the medical system described below is merely provided for illustration purposes, and not intended to limit the scope of the present disclosure.

In the present disclosure, the term “image” may refer to a two-dimensional (2D) image, a three-dimensional (3D) image, or a four-dimensional (4D) image. In some embodiments, the term “image” may refer to an image of a region (e.g., a region of interest (ROI)) of a subject. As described above, the image may be a CT image, a PET image, an MR image, a fluoroscopy image, an ultrasound image, an Electronic Portal Imaging Device (EPID) image, etc.

As used herein, a representation of an object (e.g., a patient, a subject, or a portion thereof) in an image may be referred to as an “object” for brevity. For instance, a representation of an organ or tissue (e.g., a heart, a liver, a lung) in an image may be referred to as an organ or tissue for brevity. Further, an image including a representation of an object may be referred to as an image of an object or an image including an object for brevity. Still further, an operation performed on a representation of an object in an image may be referred to as an operation performed on an object for brevity. For instance, a segmentation of a portion of an image including a representation of an organ or tissue from the image may be referred to as a segmentation of an organ or tissue for brevity.

During a scan of the heart of a patient, the heart beats ceaselessly, and coronary arteries of the heart may undergo relatively intense motions. The intense motion may introduce motion artifacts in an image of the heart. The motion artifacts may need to be corrected to obtain a target image (also referred to as a corrected image) of the heart for improving the image quality.

An aspect of the present disclosure relates to systems and methods for motion correction. A processing device may obtain an original image including a motion artifact. The processing device may obtain a target motion correction model. The processing device may generate a target image by removing the motion artifact from the original image using the target motion correction model.

Accordingly, the target image without motion artifact may be directly generated based on the original image using the target motion correction model. In some embodiments, the target motion correction model may be generated based on deep learning. With the target motion correction model obtained based on deep learning, the image processing process (e.g., motion correction) may be simplified, and accordingly the efficiency and the accuracy of the image processing process may be improved. Traditionally, a motion vector field may be determined by estimating a motion trend of a subject using a plurality of images corresponding to different time points, and motion artifacts may be corrected based on the motion vector field. According to some embodiments of the present disclosure, the target image without motion artifact may be directly generated based on the original image using the target motion correction model without determining a motion vector field, a scanning time of the subject may be shortened, a radiation dose received by the subject may be reduced, and errors generated in the process of determining the motion vector field may be avoided. In addition, the motion correction in the present disclosure may be performed in an image post-processing process, which may effectively improve the processing efficiency of the image.

Another aspect of the present disclosure relates to systems and methods for motion correction. The processing device may obtain a plurality of preliminary models of different structures. The processing device may obtain a plurality of training samples. The plurality of training samples may include at least one first training sample and at least one second training sample. In some embodiments, the at least one first training sample may be associated with at least one image generated by an imaging device. The at least one second training sample may be associated with at least one simulated image. Each training sample may include a first sample image and a first reference image. The processing device may generate a target motion correction model by training each preliminary model of the plurality of preliminary models using the plurality of training samples.

Accordingly, the target motion correction model may be trained based on different types of training samples, which may improve the accuracy of motion artifact correction of the target motion correction model. In addition, a plurality of candidate motion correction models may be obtained by training the plurality of preliminary models, and the target motion correction model may be selected from the plurality of candidate motion correction models based on a plurality of values of a loss function corresponding to the plurality of candidate motion correction models. Therefore, compared with other candidate motion correction models, the selected target motion correction model may be more suitable for motion correction. For example, the target motion correction model may correct artifacts of the coronary arteries of the heart in a medical image efficiently and accurately.

In addition, the systems and methods for motion correction and the target motion correction model disclosed in the present disclosure can correct a CT image obtained using any CT scanning mode, including but not limited to a computed tomographic plain scan, a spiral scan, etc., The systems and methods for motion correction and the target motion correction model disclosed in the present disclosure can correct a CT image reconstructed using any reconstruction algorithms, including but not limited to an analytic reconstruction algorithm, an iterative reconstruction algorithm, etc.

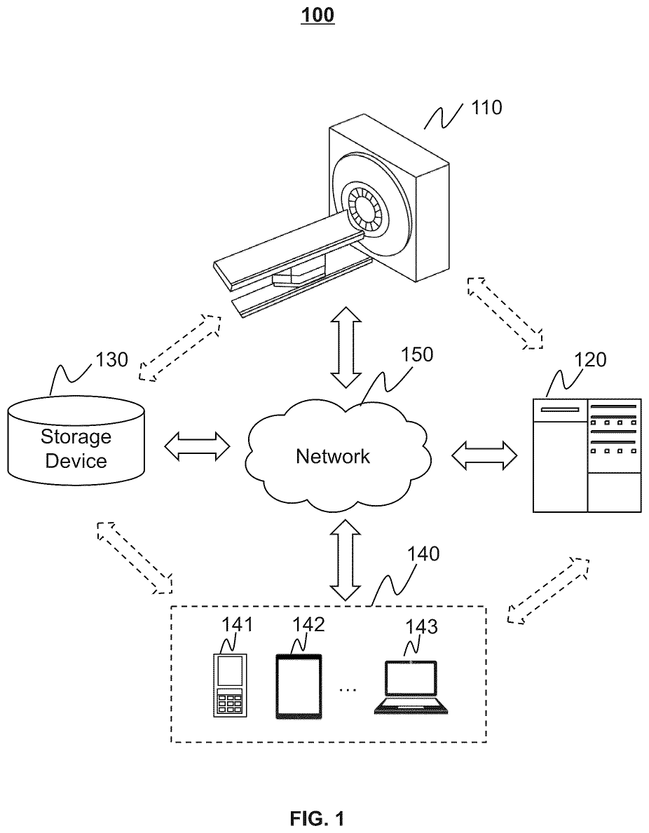

FIG. 1 is a schematic diagram illustrating an exemplary medical system according to some embodiments of the present disclosure. As illustrated in FIG. 1, the medical system 100 may include a medical device 110, a processing device 120, a storage device 130, a terminal device 140, and a network 150. In some embodiments, two or more components of the medical system 100 may be connected to and/or communicate with each other via a wireless connection, a wired connection, or a combination thereof. The medical system 100 may include various types of connection between its components. For example, the medical device 110 may be connected to the processing device 120 through the network 150, or connected to the processing device 120 directly as illustrated by the bidirectional dotted arrow connecting the medical device 110 and the processing device 120 in FIG. 1. As another example, the terminal device 140 may be connected to the processing device 120 through the network 150, or connected to the processing device 120 directly as illustrated by the bidirectional dotted arrow connecting the terminal device 140 and the processing device 120 in FIG. 1. As still another example, the storage device 130 may be connected to the medical device 110 through the network 150, or connected to the medical device 110 directly as illustrated by the bidirectional dotted arrow connecting the medical device 110 and the storage device 130 in FIG. 1. As still another example, the storage device 130 may be connected to the terminal device 140 through the network 150, or connected to the terminal device 140 directly as illustrated by the bidirectional dotted arrow connecting the terminal device 140 and the storage device 130 in FIG. 1.

The medical device 110 may be configured to acquire imaging data relating to a subject. The imaging data relating to a subject may include an image (e.g., an image slice), projection data, or a combination thereof. In some embodiments, the imaging data may be two-dimensional (2D) imaging data, three-dimensional (3D) imaging data, four-dimensional (4D) imaging data, or the like, or any combination thereof. The subject may be biological or non-biological. For example, the subject may include a patient, a man-made object, etc. As another example, the subject may include a specific portion, an organ, and/or tissue of the patient. Specifically, the subject may include the head, the neck, the thorax, the heart, the stomach, a blood vessel, soft tissue, a tumor, or the like, or any combination thereof. In the present disclosure, “object” and “subject” are used interchangeably.

In some embodiments, the medical device 110 may include a single modality imaging device. For example, the medical device 110 may include a positron emission tomography (PET) device, a single-photon emission computed tomography (SPECT) device, a magnetic resonance imaging (MRI) device (also referred to as an MR device, an MR scanner), a computed tomography (CT) device (e.g., a spiral CT, an electron beam CT, an energy spectrum CT), an ultrasound (US) device, an X-ray imaging device, a digital subtraction angiography (DSA) device, a magnetic resonance angiography (MRA) device, a computed tomography angiography (CTA) device, or the like, or any combination thereof. In some embodiments, the medical device 110 may include a multi-modality imaging device. Exemplary multi-modality imaging devices may include a PET-CT device, a PET-MRI device, a SPET-CT device, or the like, or any combination thereof. The multi-modality imaging device may perform multi-modality imaging simultaneously. For example, the PET-CT device may generate structural X-ray CT data and functional PET data simultaneously in a single scan. The PET-MRI device may generate MRI data and PET data simultaneously in a single scan.

In some embodiments, the medical device 110 may transmit the image data via the network 150 to the processing device 120, the storage device 130, and/or the terminal device 140. For example, the image data may be sent to the processing device 120 for further processing or may be stored in the storage device 130.

The processing device 120 may process data and/or information. The data and/or information may be obtained from the medical device 110 or retrieved from the storage device 130, the terminal device 140, and/or an external device (external to the medical system 100) via the network 150. For example, the processing device 120 may obtain an original image including a motion artifact. As another example, the processing device 120 may obtain a target motion correction model. As still another example, the processing device 120 may generate a target image by removing a motion artifact from an original image using a target motion correction model. As still another example, the processing device 120 may obtain a plurality of preliminary models of different structures. As still another example, the processing device 120 may obtain a plurality of training samples. As still another example, the processing device 120 may generate a target motion correction model by training each preliminary model of a plurality of preliminary models using a plurality of training samples. In some embodiments, the processing device 120 may be a single server or a server group. The server group may be centralized or distributed. In some embodiments, the processing device 120 may be local or remote. For example, the processing device 120 may access information and/or data from the medical device 110, the storage device 130, and/or the terminal device 140 via the network 150. As another example, the processing device 120 may be directly connected to the medical device 110, the terminal device 140, and/or the storage device 130 to access information and/or data. In some embodiments, the processing device 120 may be implemented on a cloud platform. For example, the cloud platform may include a private cloud, a public cloud, a hybrid cloud, a community cloud, a distributed cloud, an inter-cloud, a multi-cloud, or the like, or any combination thereof. In some embodiments, the processing device 120 may be part of the terminal device 140. In some embodiments, the processing device 120 may be part of the medical device 110.

In some embodiments, the generation, training, and/or updating of the target motion correction model may be performed on a processing device, while the application of the target motion correction model may be performed on a different processing device. In some embodiments, the generation and/or updating of the target motion correction model may be performed on a processing device of a system different from the medical system 100 or a server different from a server including the processing device 120 on which the application of the target motion correction model is performed. For instance, the generation and/or updating of the target motion correction model may be performed on a first system of a vendor who provides and/or maintains such a target motion correction model and/or has access to training samples used to generate the target motion correction model, while motion correction based on the provided target motion correction model may be performed on a second system of a client of the vendor. In some embodiments, the generation and/or updating of the target motion correction model may be performed on a first processing device of the medical system 100, while the application of the target motion correction model may be performed on a second processing device of the medical system 100. In some embodiments, the generation and/or updating of the target motion correction model may be performed online in response to a request for motion correction. In some embodiments, the generation and/or updating of the target motion correction model may be performed offline.

In some embodiments, the target motion correction model may be generated, trained, and/or updated (or maintained) by, e.g., the manufacturer of the medical device 110 or a vendor. For instance, the manufacturer or the vendor may load the target motion correction model into the medical system 100 or a portion thereof (e.g., the processing device 120) before or during the installation of the medical device 110 and/or the processing device 120, and maintain or update the target motion correction model from time to time (periodically or not). The maintenance or update may be achieved by installing a program stored on a storage device (e.g., a compact disc, a USB drive, etc.) or retrieved from an external source (e.g., a server maintained by the manufacturer or vendor) via the network 150. The program may include a new model (e.g., a new motion correction model) or a portion thereof that substitutes or supplements a corresponding portion of the target motion correction model.

The storage device 130 may store data, instructions, and/or any other information. In some embodiments, the storage device 130 may store data obtained from the medical device 110, the processing device 120, and/or the terminal device 140. The data may include image data acquired by the processing device 120, algorithms and/or models for processing the image data, etc. For example, the storage device 130 may store an original image including a motion artifact obtained from a medical device (e.g., the medical device 110). As another example, the storage device 130 may store a target motion correction model. As still another example, the storage device 130 may store a target image determined by the processing device 120. As still another example, the storage device 130 may store a plurality of preliminary models. As still another example, the storage device 130 may store a plurality of training samples. In some embodiments, the storage device 130 may store data and/or instructions that the processing device 120, and/or the terminal device 140 may execute or use to perform exemplary methods described in the present disclosure. In some embodiments, the storage device 130 may include a mass storage, a removable storage, a volatile read-and-write memory, a read-only memory (ROM), or the like, or any combination thereof. Exemplary mass storages may include a magnetic disk, an optical disk, a solid-state drive, etc. Exemplary removable storages may include a flash drive, a floppy disk, an optical disk, a memory card, a zip disk, a magnetic tape, etc. Exemplary volatile read-and-write memories may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may be connected to the network 150 to communicate with one or more other components in the medical system 100 (e.g., the processing device 120, the terminal device 140). One or more components in the medical system 100 may access the data or instructions stored in the storage device 130 via the network 150. In some embodiments, the storage device 130 may be integrated into the medical device 110 or the terminal device 140.

The terminal device 140 may be connected to and/or communicate with the medical device 110, the processing device 120, and/or the storage device 130. In some embodiments, the terminal device 140 may include a mobile device 141, a tablet computer 142, a laptop computer 143, or the like, or any combination thereof. For example, the mobile device 141 may include a mobile phone, a personal digital assistant (PDA), a gaming device, a navigation device, a point of sale (POS) device, a laptop, a tablet computer, a desktop, or the like, or any combination thereof. In some embodiments, the terminal device 140 may include an input device, an output device, etc. The input device may include alphanumeric and other keys that may be input via a keyboard, a touchscreen (for example, with haptics or tactile feedback), a speech input, an eye tracking input, a brain monitoring system, or any other comparable input mechanism. Other types of the input device may include a cursor control device, such as a mouse, a trackball, or cursor direction keys, etc. The output device may include a display, a printer, or the like, or any combination thereof.

The network 150 may include any suitable network that can facilitate the exchange of information and/or data for the medical system 100. In some embodiments, one or more components of the medical system 100 (e.g., the medical device 110, the processing device 120, the storage device 130, the terminal device 140, etc.) may communicate information and/or data with one or more other components of the medical system 100 via the network 150. For example, the processing device 120 and/or the terminal device 140 may obtain an original image from the medical device 110 via the network 150. As another example, the processing device 120 and/or the terminal device 140 may obtain information stored in the storage device 130 via the network 150. The network 150 may be and/or include a public network (e.g., the Internet), a private network (e.g., a local area network (LAN), a wide area network (WAN), etc.), a wired network (e.g., an Ethernet network), a wireless network (e.g., a Wi-Fi network), a cellular network (e.g., a long term evolution (LTE) network), a frame relay network, a virtual private network (VPN), a satellite network, a telephone network, routers, hubs, witches, server computers, and/or any combination thereof. For example, the network 150 may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network 150 may include one or more network access points. For example, the network 150 may include wired and/or wireless network access points such as base stations and/or internet exchange points through which one or more components of the medical system 100 may be connected to the network 150 to exchange data and/or information.

This description is intended to be illustrative, and not to limit the scope of the present disclosure. Many alternatives, modifications, and variations will be apparent to those skilled in the art. The features, structures, methods, and other characteristics of the exemplary embodiments described herein may be combined in various ways to obtain additional and/or alternative exemplary embodiments. However, those variations and modifications do not depart the scope of the present disclosure. In some embodiments, the medical system 100 may include one or more additional components and/or one or more components of the medical system 100 described above may be omitted. Additionally or alternatively, two or more components of the medical system 100 may be integrated into a single component. A component of the medical system 100 may be implemented on two or more sub-components.

FIG. 2 is a schematic diagram illustrating exemplary hardware and/or software components of an exemplary computing device on which the processing device 120 may be implemented according to some embodiments of the present disclosure. As illustrated in FIG. 2, a computing device 200 may include a processor 210, storage 220, an input/output (I/O) 230, and a communication port 240.

The processor 210 may execute computer instructions (e.g., program code) and perform functions of the processing device 120 in accordance with techniques described herein. The computer instructions may include, for example, routines, programs, objects, components, data structures, procedures, modules, and functions, which perform particular functions described herein. For example, the processor 210 may process image data obtained from the medical device 110, the terminal device 140, the storage device 130, and/or any other component of the medical system 100. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combination thereof.

Merely for illustration, only one processor is described in the computing device 200. However, it should be noted that the computing device 200 in the present disclosure may also include multiple processors. Thus operations and/or method steps that are performed by one processor as described in the present disclosure may also be jointly or separately performed by the multiple processors. For example, if in the present disclosure the processor of the computing device 200 executes both process A and process B, it should be understood that process A and process B may also be performed by two or more different processors jointly or separately in the computing device 200 (e.g., a first processor executes process A and a second processor executes process B, or the first and second processors jointly execute processes A and B).

The storage 220 may store data/information obtained from the medical device 110, the terminal device 140, the storage device 130, and/or any other component of the medical system 100. The storage 220 may be similar to the storage device 130 described in connection with FIG. 1, and the detailed descriptions are not repeated here.

The I/O 230 may input and/or output signals, data, information, etc. In some embodiments, the I/O 230 may enable a user interaction with the processing device 120. In some embodiments, the I/O 230 may include an input device and an output device. Examples of the input device may include a keyboard, a mouse, a touchscreen, a microphone, a sound recording device, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touchscreen, or the like, or a combination thereof.

The communication port 240 may be connected to a network (e.g., the network 150) to facilitate data communications. The communication port 240 may establish connections between the processing device 120 and the medical device 110, the terminal device 140, and/or the storage device 130. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G), or the like, or any combination thereof. In some embodiments, the communication port 240 may be and/or include a standardized communication port, such as RS232, RS485. In some embodiments, the communication port 240 may be a specially designed communication port. For example, the communication port 240 may be designed in accordance with the digital imaging and communications in medicine (DICOM) protocol.

FIG. 3 is a schematic diagram illustrating exemplary hardware and/or software components of an exemplary mobile device according to some embodiments of the present disclosure. In some embodiments, the terminal device 140 and/or the processing device 120 may be implemented on a mobile device 300, respectively.

As illustrated in FIG. 3, the mobile device 300 may include a communication platform 310, a display 320, a graphics processing unit (GPU) 330, a central processing unit (CPU) 340, an I/O 350, a memory 360, and storage 390. In some embodiments, any other suitable component, including but not limited to a system bus or a controller (not shown), may also be included in the mobile device 300.

In some embodiments, the communication platform 310 may be configured to establish a connection between the mobile device 300 and other components of the medical system 100, and enable data and/or signal to be transmitted between the mobile device 300 and other components of the medical system 100. For example, the communication platform 310 may establish a wireless connection between the mobile device 300 and the medical device 110, and/or the processing device 120. The wireless connection may include, for example, a Bluetooth™ link, a Wi-Fi™ link, a WiMax™ link, a WLAN link, a ZigBee link, a mobile network link (e.g., 3G, 4G, 5G), or the like, or any combination thereof. The communication platform 310 may also enable the data and/or signal between the mobile device 300 and other components of the medical system 100. For example, the communication platform 310 may transmit data and/or signals inputted by a user to other components of the medical system 100. The inputted data and/or signals may include a user instruction. As another example, the communication platform 310 may receive data and/or signals transmitted from the processing device 120. The received data and/or signals may include imaging data acquired by the medical device 110.

In some embodiments, a mobile operating system (OS) 370 (e.g., iOS™, Android™, Windows Phone™, etc.) and one or more applications (App(s)) 380 may be loaded into the memory 360 from the storage 390 in order to be executed by the CPU 340. The applications 380 may include a browser or any other suitable mobile apps for receiving and rendering information from the processing device 120. User interactions with the information stream may be achieved via the I/O 350 and provided to the processing device 120 and/or other components of the medical system 100 via the network 150.

To implement various modules, units, and their functionalities described in the present disclosure, computer hardware platforms may be used as the hardware platform(s) for one or more of the elements described herein. A computer with user interface elements may be used to implement a personal computer (PC) or another type of work station or terminal device, although a computer may also act as a server if appropriately programmed. It is believed that those skilled in the art are familiar with the structure, programming and general operation of such computer equipment and as a result the drawings should be self-explanatory.

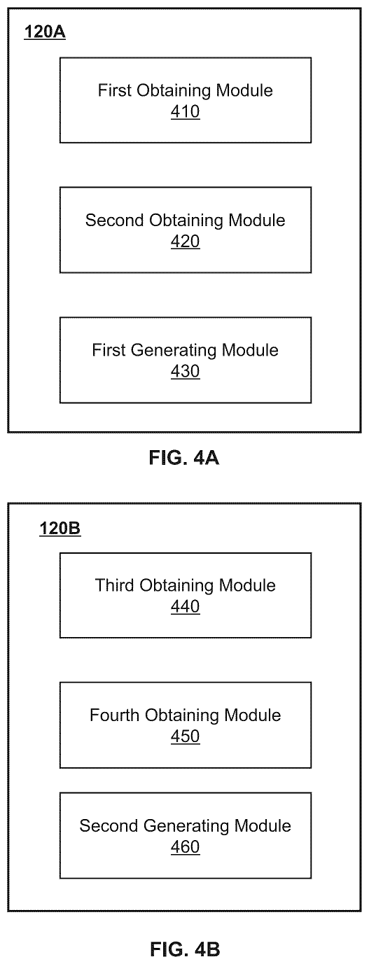

FIGS. 4A and 4B are block diagrams illustrating exemplary processing devices according to some embodiments of the present disclosure. In some embodiments, the processing device 120A and the processing device 120B may be embodiments of the processing device 120 as described in connection with FIG. 1. In some embodiments, the processing device 120A and the processing device 120B may be respectively implemented on a processing unit (e.g., the processor 210 illustrated in FIG. 2, or the CPU 340 as illustrated in FIG. 3). Merely by way of example, the processing device 120A may be implemented on the CPU 340 of a terminal device, and the processing device 120B may be implemented on the computing device 200. Alternatively, the processing device 120A and the processing device 120B may be implemented on the same computing device 200, or the same CPU 340. For example, the processing device 120A and the processing device 120B may be implemented on the same computing device 200.

The processing device 120A may be configured to obtain and/or process data/information relating to model application. In some embodiments, the processing device 120A may include a first obtaining module 410, a second obtaining module 420, and a first generating module 430.

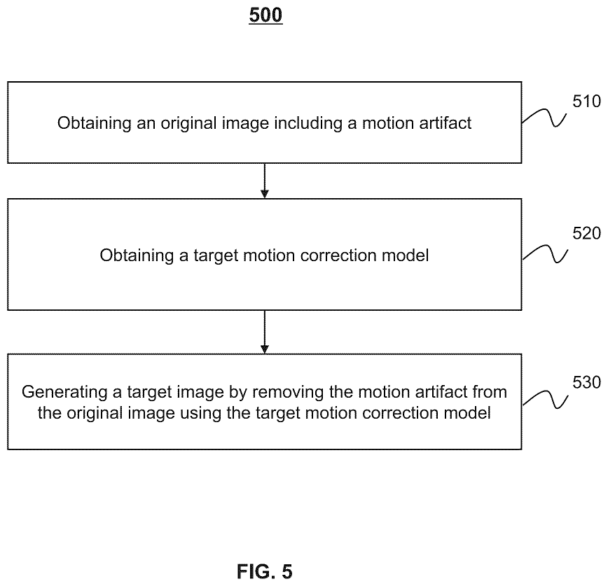

The first obtaining module 410 may be configured to obtain an original image including a motion artifact. For example, the first obtaining module 410 may obtain an original image from one or more components (e.g., the storage device 130, the storage device 220, the storage 390, the terminal device 140, the medical device 110) of the medical system 100 or an external storage device of the medical system 100. More descriptions regarding the obtaining of the original image may be found elsewhere in the present disclosure (e.g., operation 510 in FIG. 5 and the description thereof).

The second obtaining module 420 may be configured to obtain a target motion correction model. For example, the second obtaining module 420 may obtain a target motion correction model from one or more components (e.g., the storage device 130, the storage device 220, the storage 390, the terminal device 140) of the medical system 100 or an external storage device of the medical system 100. More descriptions regarding the obtaining of the target motion correction model may be found elsewhere in the present disclosure (e.g., operation 520 in FIG. 5 and the description thereof).

The first generating module 430 may be configured to generate a target image by removing a motion artifact from an original image using a target motion correction model. More descriptions regarding the generating of the target image may be found elsewhere in the present disclosure (e.g., operation 530 in FIG. 5 and the description thereof).

The processing device 120B may be configured to obtain and/or process data/information relating to model training. In some embodiments, the processing device 120B may include a third obtaining module 440, a fourth obtaining module 450, and a second generating module 460.

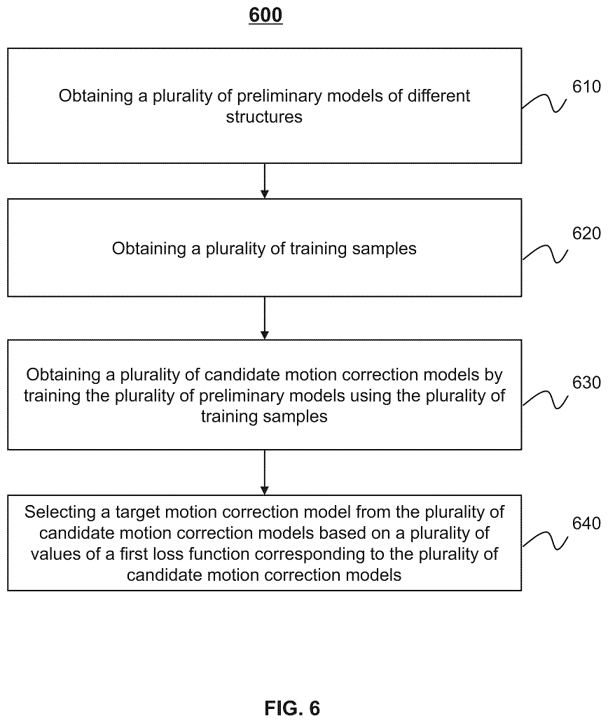

The third obtaining module 440 may be configured to obtain a plurality of preliminary models of different structures. More descriptions regarding the obtaining of the plurality of preliminary models may be found elsewhere in the present disclosure (e.g., operation 610 in FIG. 6 and the description thereof).

The fourth obtaining module 450 may be configured to obtain a plurality of training samples. In some embodiments, the plurality of training samples may include at least one first training sample and at least one second training sample. The at least one first training sample may be associated with at least one image generated by a medical device (e.g., an imaging device). The at least one second training sample may be associated with at least one simulated image. More descriptions regarding the obtaining of the plurality of training samples may be found elsewhere in the present disclosure (e.g., operation 620 in FIG. 6 and the description thereof).

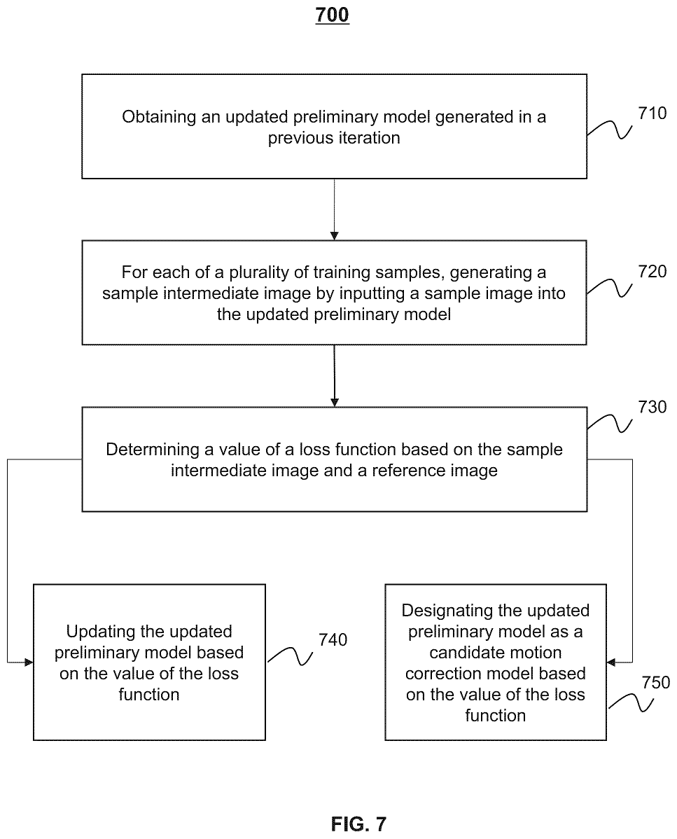

The second generating module 460 may be configured to generate a target motion correction model. In some embodiments, the second generating module 460 may obtain a plurality of candidate motion correction models by training a plurality of preliminary models using a plurality of training samples. In some embodiments, the second generating module 460 may select a target motion correction model from a plurality of candidate motion correction models based on a plurality of values of a loss function corresponding to the plurality of candidate motion correction models. More descriptions regarding the generating of the target motion correction model may be found elsewhere in the present disclosure (e.g., FIGS. 6, 7 and the description thereof).

The modules in the processing device 120A and the processing device 120B may be connected to or communicate with each other via a wired connection or a wireless connection. The wired connection may include a metal cable, an optical cable, a hybrid cable, or the like, or any combination thereof. The wireless connection may include a local area network (LAN), a wide area network (WAN), a Bluetooth, a ZigBee, a near field communication (NFC), or the like, or any combination thereof. In some embodiments, the processing device 120A and the processing device 120B may be combined as a single processing device. In some embodiments, the processing device 120A and/or the processing device 120B may include one or more additional modules. For example, the processing device 120A and/or the processing device 120B may also include a transmission module (not shown) configured to transmit data and/or information (e.g., an original image, a target image, a target motion correction model) to one or more components (e.g., the medical device 110, the terminal device 140, the storage device 130) of the medical system 100. As another example, the processing device 120A and/or the processing device 120B may include a storage module (not shown) used to store information and/or data (e.g., an original image, a target image, a target motion correction model, a plurality of training samples, a plurality of preliminary models) associated with motion correction. In some embodiments, two or more of the modules may be combined into a single module, and any one of the modules may be divided into two or more units. For example, the first obtaining module 410 and the second obtaining module 420 may be combined as a single module. As another example, the third obtaining module 440 and the fourth obtaining module 450 may be combined as a single module. As still another example, the first obtaining module 410, the second obtaining module 420, the third obtaining module 440 and/or the fourth obtaining module 450 may be combined as a single module of a combined processing device that has functions of both the processing device 120A and the processing device 120B. As a further example, the first generating module 430 and the second generating module 460 may be combined as a single module of the combined processing device.

FIG. 5 is a flowchart illustrating an exemplary process for generating a target image according to some embodiments of the present disclosure. In some embodiments, process 500 may be executed by the medical system 100. For example, the process 500 may be implemented as a set of instructions (e.g., an application) stored in a storage device (e.g., the storage device 130, the storage device 220, and/or the storage 390). In some embodiments, the processing device 120A (e.g., the processor 210 of the computing device 200, the CPU 340 of the mobile device 300, and/or one or more modules illustrated in FIG. 4A) may execute the set of instructions and may accordingly be directed to perform the process 500. The operations of the illustrated process presented below are intended to be illustrative. In some embodiments, the process 500 may be accomplished with one or more additional operations not described and/or without one or more of the operations discussed. Additionally, the order of the operations of process 500 illustrated in FIG. 5 and described below is not intended to be limiting.

In 510, the processing device 120A (e.g., the first obtaining module 410) may obtain an original image (also referred to as an initial image) including a motion artifact.

As used herein, an original image refers to an image to be corrected. In some embodiments, the original image may include a motion artifact. As used herein, an artifact refers to any feature in an image which is not present in an original imaged subject. The motion artifact may be caused by a motion of a subject during a scan of the subject. The motion of the subject may include a posture motion and a physiological motion. As used herein, a posture motion of the subject refers to a rigid motion of a portion (e.g., the head, a leg, a hand) of the subject. For example, the rigid motion may include a translational and/or rotational motion of the portion of the subject. Exemplary rigid motion may include the rotating or nodding of the head of the subject, legs motion, hands motion, and so on. The physiological motion may include a cardiac motion, a respiratory motion, a blood flow, a gastrointestinal motion, a skeletal muscle motion, a brain motion (e.g., a brain pulsation), or the like, or any combination thereof. For example, a cardiac motion refers to the motion of tissue or parts in the heart.

In some embodiments, the original image may be a medical image. For example, the original image may be associated with a specific portion (e.g., the head, the thorax, the abdomen), an organ (e.g., a lung, the liver, the heart, the stomach), and/or tissue (e.g., muscle tissue, connective tissue, epithelial tissue, nervous tissue) of a human or an animal.

In some embodiments, the original image may include a CT image, an MRI image, a PET-CT image, an SPECT-MRI image, or the like. In some embodiments, the original image may include a two-dimensional (2D) image, a three-dimensional (3D) image, a four-dimensional (4D) image, or the like. In some embodiments, the medical device 110 may obtain scan data (e.g., CT scan data) via scanning (e.g., a CT scanning) a subject or a part of the subject. The processing device 120A may generate the original image (e.g., a reconstructed image) based on the scan data generated by the medical device 110 according to one or more reconstruction algorithms. Exemplary reconstruction algorithms may include an analytic reconstruction algorithm, an iterative reconstruction algorithm, a Fourier-based reconstruction algorithm, or the like, or any combination thereof. Exemplary analytic reconstruction algorithms may include a filter back projection (FBP) algorithm, a back-projection filter (BFP) algorithm, or the like, or any combination thereof. Exemplary iterative reconstruction algorithms may include a maximum likelihood expectation maximization (ML-EM), an ordered subset expectation maximization (OSEM), a row-action maximum likelihood algorithm (RAMLA), a dynamic row-action maximum likelihood algorithm (DRAMA), or the like, or any combination thereof. Exemplary Fourier-based reconstruction algorithm may include a classical direct Fourier algorithm, a non-uniform fast Fourier transform (NUFFT) algorithm, or the like, or any combination thereof.

In some embodiments, the processing device 120A may obtain the original image from one or more components (e.g., the medical device 110, the terminal device 140, the storage device 130) of the medical system 100 or an external storage device via the network 150. In some embodiments, the processing device 120A may obtain the original image from the I/O 230 of the computing device 200 via the communication port 240, and/or the I/O 350 of the mobile device 300 via the communication platform 310.

In 520, the processing device 120A (e.g., the second obtaining module 420) may obtain a target motion correction model.

As used herein, a target motion correction model refers to an algorithm or process configured to correct motion artifact(s) of an image. In some embodiments, the target motion correction model may be constructed based on a convolutional neural network (CNN), a fully convolutional neural network (FCN), a generative adversarial network (GAN), a U-shape network (UNet), a residual network (ResNet), a dense convolutional network (DenseNet), a deep stacking network, a deep belief network (DBN), a stacked auto-encoders (SAE), a logistic regression (LR) model, a support vector machine (SVM) model, a decision tree model, a naive Bayesian model, a random forest model, a restricted Boltzmann machine (RBM), a gradient boosting decision tree (GBDT) model, a LambdaMART model, an adaptive boosting model, a recurrent neural network (RNN) model, a hidden Markov model, a perceptron neural network model, a Hopfield network model, or the like, or any combination thereof. In some embodiments, the target motion correction model may be constructed based on a plurality of types of networks. For example, the target motion correction model may be constructed based on a CNN, a RNN, and a ResNet.

In some embodiments, the target motion correction model may be determined by training one or more preliminary models using a plurality of training samples. In some embodiments, the processing device 120A may train the one or more preliminary models to generate the target motion correction model according to a machine learning algorithm. The machine learning algorithm may include an artificial neural network algorithm, a deep learning algorithm, a decision tree algorithm, an association rule algorithm, an inductive logic programming algorithm, a support vector machine algorithm, a clustering algorithm, a Bayesian network algorithm, a reinforcement learning algorithm, a representation learning algorithm, a similarity and metric learning algorithm, a sparse dictionary learning algorithm, a genetic algorithm, a rule-based machine learning algorithm, or the like, or any combination thereof. The machine learning algorithm used to generate the target motion correction model may be a supervised learning algorithm, a semi-supervised learning algorithm, an unsupervised learning algorithm, or the like. More descriptions for obtaining the target motion correction model may be found elsewhere in the present disclosure (e.g., FIGS. 6-7, and descriptions thereof).

In 530, the processing device 120A (e.g., the first generating module 430) may generate a target image by removing the motion artifact from the original image using the target motion correction model.

As used herein, a target image refers to a corrected image that is with substantial removal of a motion artifact (e.g., the motion artifact included in the original image). In some embodiments, the target image may be a 2D image, a 3D image, or the like.

In some embodiments, the processing device 120A may input the original image into the target motion correction model. The target motion correction model may output the target image by processing the original image. For example, the processing device 120A may input a 2D original image into the target motion correction model. The target motion correction model may output a 2D target image by processing the 2D original image. As another example, the processing device 120A may input a 3D original image into the target motion correction model. The target motion correction model may output a 3D target image by processing the 3D original image. As still another example, the processing device 120A may input a 3D original image into the target motion correction model. The target motion correction model may output one or more 2D target images by processing the 3D original image. As a further example, the processing device 120A may input one or more 2D original images into the target motion correction model. The target motion correction model may output a 3D target image by processing the 2D original image(s).

For illustration purposes, the processing device 120A may obtain (in 510) an original CT image of the heart acquired by a CT device. The original CT image may include a motion artifact. The processing device 120A may (in 530) input the original CT image into the target motion correction model. The target motion correction model may output a target CT image of the heart. The target CT image may be with substantial removal of the motion artifact from the original CT image. Accordingly, the original image may be directly corrected using the target motion correction model without performing a segmentation operation on the original image, which may improve the efficiency and accuracy of motion correction.

In some embodiments, the processing device 120A may divide the original image into a plurality of original sub-images. An original sub-image may have any size. The sizes of different original sub-images may be the same or different. For example, the processing device 120A may divide the original image into the plurality of original sub-images with a size of K pixels×M pixels×N pixels. K, M and N may be any positive number, for example, 5, 10, 100, and 200. K, M and N may be the same or different. In some embodiments, the original sub-image may be a 2D image, a 3D image, or the like. For example, if the original image is a 3D image, the original sub-image may be a 2D image or a 3D image. The processing device 120A may generate a plurality of target sub-images by inputting the plurality of original sub-images into the target motion correction model. For example, the processing device 120A may input each original sub-image of the plurality of original sub-images into the target motion correction model. The target motion correction model may output a target sub-image corresponding to the each original sub-image of the plurality of original sub-images. In some embodiments, the processing device 120A may input the original image into the target motion correction model. The target motion correction model may divide the original image into a plurality of original sub-images, and output the plurality of target sub-images corresponding to the plurality of original sub-images.

Further, the processing device 120A may generate the target image by combining the plurality of target sub-images. For example, the processing device 120A may generate the target image (e.g., a 3D image) by combining the plurality of target sub-images (e.g., a plurality of 2D sub-images, a plurality of 3D sub-images) according to one or more image stitching algorithms. Exemplary image stitching algorithms may include a parallax-tolerant image stitching algorithm, a perspective preserving distortion for image stitching, a projection interpolation image stitching algorithm, or the like, or any combination thereof. In some embodiments, the target motion correction model may combine the plurality of target sub-images, and output the target image.

Accordingly, the plurality of target sub-images may be generated by processing the plurality of original sub-images using the target motion correction model, and the target image may be generated by combining the plurality of target sub-images. Since a size of the original sub-image is smaller than a size of the original image, the processing speed of the target motion correction model may be improved, and accordingly the efficiency of image processing may be improved. In addition, by inputting an original sub-image of the coronary artery into the target motion correction model, the target motion correction model may extract a local feature of the coronary artery easily.

In some embodiments, the processing device 120A may divide the original image into a plurality of original sub-images. The processing device 120A may generate a plurality of first target sub-images by inputting the plurality of original sub-images into the target motion correction model. The processing device 120A may generate a first target image by combining the plurality of first target sub-images. Further, the processing device 120A may divide the first target image into a plurality of second target sub-images. The processing device 120A may generate a plurality of third target sub-images by inputting the plurality of second target sub-images into the target motion correction model. The processing device 120A may generate a second target image by combining the plurality of third target sub-images. In some embodiments, the operations may be repeated until the correction effect of a target image (e.g., the first target image, the second target image) satisfies a condition (e.g., the motion artifact in the target image is less than a preset level of artifact).

In some embodiments, the original image may be a 3D image including a plurality of 2D layers. For each 2D layer of the plurality of 2D layers, the processing device 120A may obtain a plurality of reference layers adjacent to the 2D layer. A number (or count) of the plurality of the reference layers corresponding to the 2D layer may be manually set by a user of the medical system 100, or by one or more components (e.g., the processing device 120) of the medical system 100 according to different situations. The processing device 120A may generate a corrected 2D layer by inputting the 2D layer and the plurality of reference layers into the target motion correction model. For example, the processing device 120A may input the 2D layer and the plurality of reference layers into the target motion correction model, and the target motion correction model may output the corrected 2D layer by processing the 2D layer and/or the plurality of reference layers. Further, the processing device 120A may generate the target image by combining a plurality of corrected 2D layers. In the present disclosure, a 2D layer and a plurality of reference layers adjacent to the 2D layer may also referred to as a 2.5D image. For example, the processing device 120A may generate the target image by combining the plurality of corrected 2D layers according to one or more image stitching algorithms as described elsewhere in the present disclosure.

For illustration purposes, a 3D original image may include a first 2D layer, a second 2D layer, a third 2D layer, a fourth 2D layer, a fifth 2D layer, and a sixth 2D layer. For the first 2D layer, the processing device 120A may obtain the second 2D layer and the third 2D layer as the reference layers. The processing device 120A may generate a corrected first 2D layer by inputting the first 2D layer and the reference layers (e.g., the second 2D layer, the third 2D layer) into the target motion correction model. For the second 2D layer, the processing device 120A may obtain the first 2D layer and the third 2D layer as the reference layers. The processing device 120A may generate a corrected second 2D layer by inputting the second 2D layer and the reference layers (e.g., the first 2D layer, the third 2D layer) into the target motion correction model. Similarly, the processing device 120A may generate a corrected third 2D layer, a corrected fourth 2D layer, a corrected fifth 2D layer, and a corrected sixth 2D layer. The processing device 120A may generate a 3D target image by combining the corrected first 2D layer, the corrected second 2D layer, the corrected third 2D layer, the corrected fourth 2D layer, the corrected fifth 2D layer, and the corrected sixth 2D layer. For example, the processing device 120A may generate the 3D target image by combining the corrected first 2D layer, the corrected second 2D layer, the corrected third 2D layer, the corrected fourth 2D layer, the corrected fifth 2D layer, and the corrected sixth 2D layer based on an order of the first 2D layer, the second 2D layer, the third 2D layer, the fourth 2D layer, the fifth 2D layer, and the sixth 2D layer in the 3D original image. It should be noted that the six 2D layers described above is merely provided for the purposes of illustration, and not intended to limit the scope of the present disclosure. The 3D original image may include any number of 2D layers.

In some embodiments, the processing device 120A may input the plurality of 2D layers of the 3D original image into the target motion correction model. For each 2D layer, the target motion correction model may determine the plurality of reference layers adjacent to the 2D layer. The target motion correction model may generate the corrected 2D layer by processing the 2D layer and the plurality of reference layers. The target motion correction model may generate the 3D target image by combining the plurality of corrected 2D layers according to an order of the plurality of 2D layers in the 3D original image. The target motion correction model may output the 3D target image.

Accordingly, the corrected 2D layer may be obtained by inputting the 2D layer and the plurality of reference layers adjacent to the 2D layer into the target motion correction model. The target image may then be generated based on the plurality of corrected 2D layers. Since the plurality of reference layers adjacent to the 2D layer provides spatial structure information associated with the 2D layer, the stability and continuity of the corrected 2D layer generated based on the 2D layer and the plurality of reference layers may be improved. Therefore, the quality of the target image generated based on the plurality of corrected 2D layers may also be improved.

In some embodiments, for each 2D layer of the plurality of 2D layers, the processing device 120A may input the 2D layer and the plurality of reference layers adjacent to the 2D layer into the target motion correction model. The target motion correction model may output a corrected 2D layer and a plurality of corrected reference layers. The processing device 120A may generate the target image by combining a plurality of corrected 2D layers and a plurality of corrected reference layers corresponding to the each 2D layer of the plurality of 2D layers.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added in process 500. For example, process 500 may include an additional operation for transmitting the original image and the target image to a terminal device (e.g., the terminal device 140) for display. In some embodiments, the processing device 120A may transmit a second target image to the terminal device (e.g., the terminal device 140) for display. The second target image may be generated by correcting the original image using one or more existing motion correction algorithms (e.g., a motion vector field correction algorithm). A user (e.g., a doctor) may select a final target image from the target image and the second target image based on user experience. In some embodiments, the processing device 120A may perform a preprocessing operation (e.g., a denoising operation, an image enhancement operation) on the original image, and input a preprocessed image into the target motion correction model. In some embodiments, the processing device 120A may input raw data (e.g., projection data) into the target motion correction model, and the target motion correction model may output the target image.

FIG. 6 is a flowchart illustrating an exemplary process for generating a target motion correction model according to some embodiments of the present disclosure. In some embodiments, process 600 may be executed by the medical system 100. For example, the process 600 may be implemented as a set of instructions (e.g., an application) stored in a storage device (e.g., the storage device 130, the storage device 220, and/or the storage 390). In some embodiments, the processing device 120B (e.g., the processor 210 of the computing device 200, the CPU 340 of the mobile device 300, and/or one or more modules illustrated in FIG. 4B) may execute the set of instructions and may accordingly be directed to perform the process 600. The operations of the illustrated process presented below are intended to be illustrative. In some embodiments, the process 600 may be accomplished with one or more additional operations not described and/or without one or more of the operations discussed. Additionally, the order of the operations of process 600 illustrated in FIG. 6 and described below is not intended to be limiting.

In 610, the processing device 120B (e.g., the third obtaining module 440) may obtain a plurality of preliminary models of different structures.

As used herein, a preliminary model refers to a machine learning model to be trained. In some embodiments, the processing device 120B may initialize one or more parameter values of one or more parameters in the preliminary model. In some embodiments, the initialized values of the parameters may be default values determined by the medical system 100 or preset by a user of the medical system 100. In some embodiments, the processing device 120B may obtain the plurality of preliminary models from a storage device (e.g., the storage device 130) of the medical system 100 and/or an external storage device via the network 150.

In some embodiments, the plurality of preliminary models may be of different types or may have different structures. In some embodiments, the plurality of preliminary models may include a machine learning model (e.g., a deep learning model, a neural network model). Merely by way of example, the plurality of preliminary models may include a deep belief network (DBN), a stacked auto-encoders (SAE), a logistic regression (LR) model, a support vector machine (SVM) model, a decision tree model, a Naive Bayesian Model, a random forest model, a restricted Boltzmann machine (RBM), a gradient boosting decision tree (GBDT) model, a LambdaMART model, an adaptive boosting model, a recurrent neural network (RNN) model, a convolutional network model, a hidden Markov model, a perceptron neural network model, a Hopfield network model, or the like, or any combination thereof.

In 620, the processing device 120B (e.g., the fourth obtaining module 450) may obtain a plurality of training samples.

The plurality of training samples may be used to train the plurality of preliminary models. In some embodiments, each training sample may include a sample image (also referred to as a first sample image) of a sample subject and a reference image (also referred to as a first reference image) of the sample subject. A reference image may be also referred to as a gold standard image. In some embodiments, the sample image and the reference image may correspond to a same time point. For example, the sample image and the reference image may be obtained based on raw data of a same subject obtained at a same time point. The sample image may include a 2D image, a 3D image, or the like. The sample image may have a motion artifact. In some embodiments, the sample image(s) of one or more (e.g., each) training samples may have one or more types of motion artifacts (e.g., motion artifact, metal artifact, streak artifact). The reference image may be with substantial removal of the motion artifact. For example, the reference image may have no motion artifact. As another example, a motion artifact in the reference image may be less than a preset level of artifact. As used herein, a sample subject refers to a subject whose data is used for training the target motion correction model. In some embodiments, the sample subject may be the same as or similar to the subject of the original image obtained in 510. In some embodiments, a degree of similarity between the sample subject and the subject may be greater than a threshold (e.g., 80%, 85%, 90%, 95%). The degree of similarity between the sample subject and the subject may be determined based on the feature information of the sample subject and the feature information of the subject. The feature information of the sample subject (or the subject) may include the age, the gender, the body shape, the health condition, the medical history, or the like, or any combination, of the sample subject (or the subject).

In some embodiments, the plurality of training samples may include at least one first training sample and at least one second training sample. In some embodiments, the at least one first training sample may be associated with at least one image generated by a medical device (e.g., an imaging device). For example, for each first training sample, the processing device 120B may obtain the sample image including a motion artifact by scanning the sample subject using a medical device. The processing device 120B may obtain the reference image by removing or reducing the motion artifact from the sample image using one or more existing motion correction algorithms (e.g., a motion vector field correction algorithm, a deep learning algorithm).

In some embodiments, the at least one second training sample may be associated with at least one simulated image. For example, for each second training sample, the processing device 120B may obtain the reference image without a motion artifact. The processing device 120B may obtain the sample image by adding one or more types of simulated motion artifacts to the reference image. For illustration purposes, the processing device 120B may introduce simulated motion artifact(s) (e.g., a simulated motion artifact used for simulating the artifact induced by the movement of the coronary of the heart of a sample subject) into the reference image of the heart. According to some embodiments of the present disclosure, by using the at least one first training sample and at least one second training sample, the training effect of the preliminary model may be improved.

In 630, the processing device 120B (e.g., the second generating module 460) may obtain a plurality of candidate motion correction models by training the plurality of preliminary models using the plurality of training samples.

In some embodiments, for each preliminary model, the processing device 120B may obtain a candidate motion correction model by training the preliminary model using at least part of the plurality of training samples. For example, the processing device 120B may obtain the candidate motion correction model by training the preliminary model using both of the at least one first training sample and the at least one second training sample. As another example, the processing device 120B may obtain the candidate motion correction model by training the preliminary model only using the at least one first training sample or the at least one second training sample.

In some embodiments, the processing device 120B may obtain a plurality of candidate motion correction models by training the plurality of preliminary models using the plurality of training samples according to a second loss function (e.g., a combined loss function, a local loss function, a dice related loss function, a global loss function, etc.). In some embodiments, the processing device 120B may train each of the plurality of preliminary models to generate a candidate motion correction model according to one or more machine learning algorithms described elsewhere in the present disclosure.

As used herein, the combined loss function refers to a combination of one or more loss functions each of which may be associated with a local region or a global region of the heart (or the sample image(s)). For example, the combined loss function may include one or more local loss functions, a dice related loss function, a global loss function, or the like, or any combination thereof. As used herein, a local loss function refers to a loss function associated with a first local region of the heart (or the sample image(s)). In some embodiments, the local loss function may relate to a mask region. The mask region may be associated with the first local region with relatively obvious artifact(s) and/or relatively large level of artifacts in an image. Exemplary first local regions may include a coronary artery (or a portion thereof) of the heart, a myocardium (or a portion thereof) of the heart, a stent region (or a portion thereof) of the heart, etc. The processing device 120B may determine the mask region by determining a mask corresponding to the first local region of the heart. As used herein, a dice related loss function refers to a loss function associated with a second local region of the heart (or the sample image(s)). In some embodiments, the processing device 120B may determine the second local region using a segmentation algorithm (e.g., a coronary artery extraction algorithm). The first local region and the second local region may be the same or different. In some embodiments, the first local region may include the second local region. As used herein, a global loss function refers to a loss function associated with a global region of the heart (or the sample image(s)). The processing device 120B may determine the global region without segmentation in comparison with the determination of the local region.

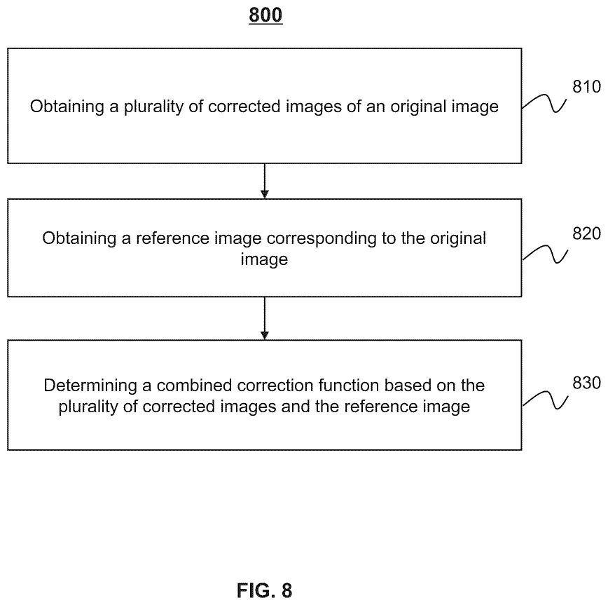

In some embodiments, the combined loss function may be pre-stored in the one or more components (e.g., the storage device 130, the storage device 220, or the storage 390) of the medical system 100 or an external storage device of the medical system 100. The processing device 120B may obtain (e.g., by retrieving) the combined loss function from the one or more components of the medical system 100 or the external storage device of the medical system 100. Alternatively, the processing device 120B may determine the combined loss function (e.g., determining and/or adjusting weights of the one or more loss functions of the combined loss function) based on a plurality of corrected images of an original image and a reference image corresponding to the original image. More descriptions regarding the obtaining of the combined loss function may be found elsewhere in the present disclosure (e.g., FIG. 8 and the description thereof).

In some embodiments, the processing device 120B may determine the target motion correction model by training the preliminary model according to an iterative operation including one or more iterations. Taking a current iteration of the one or more iterations as an example, the processing device 120B may obtain an updated preliminary model generated in a previous iteration. For the each of the plurality of training samples, the processing device 120B may generate a first sample intermediate image by inputting the sample image into the updated preliminary model. The processing device 120B may determine a value of a second loss function (e.g., a combined loss function) based on the first sample intermediate image and the reference image. Further, the processing device 120B may update the updated preliminary model based on the value of the loss function, or designate the updated preliminary model as a candidate motion correction model based on the value of the loss function. Alternatively, the processing device 120B may designate the updated preliminary model as the target motion correction model when a termination condition is satisfied. More descriptions regarding the generation of the target motion correction model may be found elsewhere in the present disclosure (e.g., FIG. 7 and descriptions thereof).

In 640, the processing device 120B (e.g., the second generating module 460) may select a target motion correction model from the plurality of candidate motion correction models based on a plurality of values of a first loss function corresponding to the plurality of candidate motion correction models.

In some embodiments, the processing device 120B may obtain at least one testing sample. The at least one testing sample may be used to select the target motion correction model from the plurality of candidate motion correction models. In some embodiments, a part or all of the testing samples may be the same as the training samples. In some embodiments, the testing sample(s) may be different from the training sample(s). A testing sample may include a second sample image and a second reference image. The second sample image may have a motion artifact. The second reference image may be with substantial removal of the motion artifact. For each candidate motion correction model, the processing device 120B may generate a second sample intermediate image by inputting the second sample image into the candidate motion correction model. For example, the processing device 120B may input the second sample image into the candidate motion correction model, and the candidate motion correction model may output the second sample intermediate image by processing the second sample image. The processing device 120B may determine a value of the first loss function (e.g., a combined loss function as described in connection with operation 630) based on the second sample intermediate image and the second reference image. The first loss function used to select the target motion correction model from the plurality of candidate motion correction models may be the same as or different from the second loss function used to train the candidate motion correction model(s) as described in connection with operation 630 (of FIG. 6) and FIG. 7. The processing device 120B may select the target motion correction model from the plurality of candidate motion correction models based on the plurality of values of the first loss function corresponding to the plurality of candidate motion correction models. For example, the processing device 120B may select a candidate motion correction model with the minimum value of the first loss function as the target motion correction model. In some embodiments, compared with other candidate motion correction models, the target motion correction model may have more layers, parameters, and/or feature maps.

According to some embodiments of the present disclosure, a plurality of candidate motion correction models of different types or structures may be trained, and the target motion correction model may be selected from the plurality of candidate motion correction models according to the first loss function (e.g., a combined loss function). Compared with other candidate motion correction models, the selected target motion correction model may be more suitable for motion correction, which may improve the efficiency and accuracy of motion correction. In addition, a cardiac motion artifact correction process may be different from other processes such as a denoising process, and a conventional model structure may not be suitable for cardiac motion artifact correction. By training a plurality of candidate motion correction models of different types or structures, and selecting the target motion correction model from the plurality of candidate motion correction models according to the first loss function (e.g., a combined loss function), the selected target motion correction model may be more suitable for cardiac motion artifact correction.

In some embodiments, the processing device 120B may verify the target motion correction model to evaluate a correction effect of the target motion correction model. In some embodiments, the processing device 120B may obtain at least one verifying sample. The at least one verifying sample may be used to evaluate the correction effect of the target motion correction model. In some embodiments, a part or all of the verifying samples may be the same as the training samples and/or the testing samples. In some embodiments, the verifying samples may be different from the training samples and/or the testing samples. A verifying sample may include a third sample image and a third reference image. The third sample image may have a motion artifact. The third reference image may be with substantial removal of the motion artifact. The processing device 120B may verify the target motion correction model using the at least one verifying sample. In some embodiments, the processing device 120B may generate a third sample intermediate image by inputting the third sample image into the target motion correction model. For example, the processing device 120B may input the third sample image into the target motion correction model, and the target motion correction model may output the third sample intermediate image by processing the third sample image. The processing device 120B may determine a value of a third loss function (e.g., a combined loss function as described in connection with operation 630) based on the third sample intermediate image and the third reference image. The third loss function used to verify the target motion correction model may be the same as or different from the first loss function used to select the target motion correction model and/or the second loss function used to train the candidate motion correction model. In some embodiments, the smaller the value of the third loss function of the target motion correction model is, the better the correction effect of the target motion correction model may be. Alternatively, the closer the value of the third loss function of the target motion correction model to a preset value is, the better the correction effect of the target motion correction model may be.

In some embodiments, the processing device 120B may determine whether the value of the third loss function satisfies a condition. In response to determining that the value of the third loss function satisfies the condition, the processing device 120B may determine the target motion correction model as a verified target motion correction model. For example, in response to determining that the value of the third loss function is less than a threshold, the processing device 120B may determine the target motion correction model as the verified target motion correction model. The threshold may be a default setting of the medical system 100 or adjustable according to different situations.

According to some embodiments of the present disclosure, by verifying the target motion correction model using the at least one verifying sample according to the third loss function (e.g., a combined loss function), the correction effect of the target motion correction model may be quantitatively evaluated, and the efficiency and accuracy of the verified target motion correction model for motion correction may be guaranteed.

According to some embodiments of the present disclosure, the target motion correction model may have a good correction effect for motion artifacts, and may not affected by other types of artifacts or image noises. Traditionally, a region of the coronary artery may be segmented from the original image, and the region of the coronary artery may be corrected to remove the motion artifact. The accuracy of segmentation may be affected by other types of artifacts or image noises, thereby affecting the correction effect for motion artifacts. In addition, by using the combined loss function including the local loss function, the dice loss function, and the global loss function, the target motion correction model may correct motion artifacts in the original image of the coronary artery without removing other types of artifacts or image noises in the original image of the coronary artery.

It should be noted that the above description regarding the process 600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the processing device 120B may obtain one preliminary model. The processing device 120B may determine the target motion correction model by training the preliminary model based on the plurality of training samples according to the second loss function (e.g., the combined loss function). In some embodiments, after the target motion correction model is generated, a user of the medical system 100 may manually adjust one or more parameter values of the target motion correction model.

In some embodiments, the processing device 120B may obtain an image. The processing device 120B may determine whether the image includes a motion artifact. In response to determining that the image does not include a motion artifact, the processing device 120B may determine the image as a reference image, and obtain a sample image by adding a simulated motion artifact to the reference image. In response to determining that the image includes a motion artifact, the processing device 120B may correct the motion artifact in the image using one or more existing motion correction algorithms (e.g., a motion vector field correction algorithm) to generated a corrected image. The processing device 120B may determine whether the correction effect of the corrected image satisfies a condition (e.g., determine whether the motion artifact in the corrected image is less than a preset level of artifact). In response to determining that the correction effect of the corrected image satisfies the condition, the processing device 120B may determine the image as a sample image, and determine the corrected image as the reference image. In response to determining that the correction effect of the corrected image does not satisfy the condition, the processing device 120B may determine the image and the corrected image as a testing sample or a verifying sample.

In some embodiments, after the target motion correction model is obtained, the processing device 120B may train a preliminary model having a same structure as the target motion correction model using a plurality of groups of training samples. A motion correction model may be generated using each group of training samples. The processing device 120B may select a final motion correction model from a plurality of motion correction models using a plurality of groups of testing samples. In some embodiments, the plurality of groups of testing samples may include a plurality of types of artifacts and/or a plurality of pathological features, which may be used to test the generalization ability of the plurality of motion correction models. In some embodiments, the processing device 120B may select the final motion correction model from the plurality of motion correction models based on a plurality of values of a loss function corresponding to the plurality of motion correction models. For example, the processing device 120B may select a motion correction model with the minimum value of the loss function as the final motion correction model.

FIG. 7 is a flowchart illustrating an exemplary process for generating a candidate motion correction model according to some embodiments of the present disclosure. In some embodiments, process 700 may be executed by the medical system 100. For example, the process 700 may be implemented as a set of instructions (e.g., an application) stored in a storage device (e.g., the storage device 130, the storage device 220, and/or the storage 390). In some embodiments, the processing device 120B (e.g., the processor 210 of the computing device 200, the CPU 340 of the mobile device 300, and/or one or more modules illustrated in FIG. 4B) may execute the set of instructions and may accordingly be directed to perform the process 700. The operations of the illustrated process presented below are intended to be illustrative. In some embodiments, the process 700 may be accomplished with one or more additional operations not described and/or without one or more of the operations discussed. Additionally, the order of the operations of process 700 illustrated in FIG. 7 and described below is not intended to be limiting. In some embodiments, one or more operations of process 700 may be performed to achieve at least part of operation 630 as described in connection with FIG. 6. For example, the process 700 may be performed to achieve a current iteration in training a candidate motion correction model or a target motion correction model. In some embodiments, a same set or different sets of training samples may be used in different iterations in training the candidate motion correction model or the target motion correction model.

In 710, the processing device 120B (e.g., the second generating module 460) may obtain an updated preliminary model generated in a previous iteration.

In some embodiments, for the current iteration being a first iteration, the processing device 120B may obtain a preliminary model as described in operation 610. For the current iteration being a subsequent iteration of the first iteration, the processing device 120B may obtain the updated preliminary model generated in the previous iteration.

In 720, for each of a plurality of training samples, the processing device 120B (e.g., the second generating module 460) may generate a sample intermediate image by inputting a sample image into the updated preliminary model.

In some embodiments, the processing device 120B may input the sample image into the updated preliminary model. The updated preliminary model may output the sample intermediate image by processing the sample image.

In 730, the processing device 120B (e.g., the second generating module 460) may determine a value of a loss function (e.g., the second loss function) based on the sample intermediate image and a reference image.

In some embodiments, the sample image may be inputted into an input layer of the updated preliminary model, and the reference image corresponding to the sample image may be inputted into an output layer of the updated preliminary model as a desired output of the updated preliminary model. The updated preliminary model may extract one or more image features (e.g., a low-level feature (e.g., an edge feature, a texture feature), a high-level feature (e.g., a semantic feature), or a complicated feature (e.g., a deep hierarchical feature) included in the sample image. Based on the extracted image features, the updated preliminary model may determine a predicted output (i.e., a sample intermediate image) of the sample image. The predicted output (i.e., the sample intermediate image) may then be compared with the desired output (e.g., the reference image) based on the loss function. As used herein, a loss function of a model may be configured to assess a difference between a predicted output (e.g., a sample intermediate image) of the model and a desired output (e.g., a reference image). In some embodiments, the loss function may be a combined loss function.

As described in connection with operation 620, the combined loss function may include one or more loss functions. In some embodiments, the combined loss function may include a combination of two or more loss functions. In some embodiments, the processing device 120B may determine the value of the combined loss function by a weighted sum of values of the one or more loss functions. In some embodiments, each of the loss functions may correspond to a specific weight. In some embodiments, different loss functions may correspond to different weights. For example, the combined loss function may include a local loss function (e.g., associated with the coronary artery), a dice related loss function associated with the coronary artery, and a global loss function, as expressed in Equation (1):

$${Loss}_{com} = {α}_{0} {Loss}_{global} + {α}_{1} {Loss}_{local} + {α}_{2} {Loss}_{dice} , \qquad ( 1 )$$

where Loss_{com} denotes the combined loss function, Loss_{local} denotes the value of the local loss function, Loss_{dice} denotes the dice related loss function, Loss_{global} denotes the global loss function, α₁ denotes a weight (also referred to as a first weight) of the local loss function, α₂ denotes a weight (also referred to as a second weight) of the dice related loss function, and do denotes a weight (also referred to as a third weight) of the global loss function. In some embodiments, a first significance of the local loss function may be higher than the second significance of the dice related loss function. For example, the value of local loss function multiplied by the first weight (i.e., α₀Loss_{global}) may be larger than the value of dice related loss function multiplied by the second weight (i.e., α₂Loss_{dice}). In some embodiments, the second significance of the dice related loss function may be higher than a third significance of the global loss function. For example, the value of the dice related loss function multiplied by the second weight (i.e., α₂Loss_{dice}) may be larger than the value of the global loss function multiplied by the third weight (i.e., α₀Loss_{global}).

In some embodiments, the combined loss function may include two local loss functions (e.g., one being associated with the coronary artery, and another one being associated with the myocardium), a dice related loss function associated with the coronary artery, and/or a global loss function. In some embodiments, a fourth significance of the local loss function associated with the myocardium may be lower than the first significance, since an artifact in the myocardium is generally less than an artifact in the coronary artery. In some embodiments, the weights (e.g., the first weight, the second weight, the third weight, and/or the fourth weight) of the one or more loss functions may be determined (or adjusted) as described in FIG. 8 and the description thereof.

In some embodiments, the processing device 120B may determine a value of a local loss function associated with a local region by determining a mask corresponding to the local region. Taking the local region associate with a coronary artery as an example, the processing device 120B may extract a centerline of the coronary artery from the reference image (e.g., using a centerline extraction algorithm or model). The centerline extraction algorithm or model may be based on morphological operators, model-fitting, medialness filter, fuzzy connectedness, connected component analysis and wave propagation, an improved Frangi's vesselness filter, a CNN-based orientation classifier, or the like, or any combination thereof. The processing device 120B may determine a mask by performing an expansion operation on the centerline. As used herein, a mask refers to a binary image including information (e.g., a size, a shape, a motion range, etc.) of the coronary artery. For example, the processing device 120B may perform the expansion operation on the centerline according to a preset radius of the coronary artery. In some embodiments, the region obtained after expansion operation may be larger than the coronary artery, such that the mask includes information of the entire coronary artery. The preset radius may be a default setting of the medical system 100 or adjustable according to the experience of a user (e.g., a doctor, an operator, or a technician). In some embodiments, the processing device 120B may extract the coronary artery from the reference image (e.g., using a coronary artery extraction algorithm or model such as a threshold segmentation algorithm or a topology extraction algorithm). The processing device 120B may determine the mask based on the extracted coronary artery. Further, the processing device 120B may determine the value of the local loss function based on the mask, the sample intermediate image, and the reference image.

In some embodiments, the processing device 120B may determine, in the sample intermediate image, a first local region (also referred to as a first mask region) corresponding to the coronary artery based on the mask and the sample intermediate image. The processing device 120B may determine, in the reference image, a second local region (also referred to as a second mask region) corresponding to the coronary artery based on the mask and the reference image. As used herein, the first local region may include one or more first sub-regions each of which corresponds to a part of the coronary artery. For example, the coronary artery may include a left coronary artery and a right coronary artery. The first local region may include two first sub-regions corresponding to the left coronary artery and the right coronary artery respectively. As another example, the coronary artery may include one or more branches. The first local region may include one or more first sub-regions corresponding to the one or more branches respectively. Similarly, the second local region may include one or more second sub-regions. Each of the one or more first sub-regions may correspond to one of the one or more second sub-regions. The processing device 120B may determine the value of the local loss function based on a difference between the first local region and the second local region. The difference between the first local region and the second local region may be determined based on the one or more first sub-regions and the one or more second sub-regions. For example, the processing device 120B may determine a partial-difference between each of the one or more first sub-regions and its corresponding second sub-region. The processing device 120B may determine the difference between the first local region and the second local region based on the one or more partial-differences (e.g., by averaging the one or more partial-differences). The larger the value of the local loss function is, the less similar the first mask region may be to the second mask region (i.e., the higher level of artifact that the first mask region has may be), and the worse the correction effect of the updated motion correction model may be. The smaller the value of the local loss function is, the more similar the first mask region may be to the second mask region (i.e., the lower level of artifact that the first mask region has may be), and the better the correction effect of the updated motion correction model may be. For instance, the processing device 120B may determine the value of the local loss function according to Equation (2) as follows:

$${Loss}_{local} = f ( M ( x ) * mask , GS * mask ) , \qquad ( 2 )$$

where mask denotes the mask, x denotes the sample image, M(⋅) denotes the updated preliminary model, M(x) denotes the sample intermediate image, GS denotes the reference image, M(x)*mask denotes the first mask region determined by multiplying the sample intermediate image and the mask according to which pixel values of the first local region in the sample intermediate image keep unchanged and pixel values of the remaining region in the sample intermediate image are changed to be 0, GS*mask denotes the second mask region determined by multiplying the reference image and the mask according to which pixel values of the second local region in the reference image keep unchanged and pixel values of the remaining region in the reference image are changed to be 0, and f(⋅) denotes a local loss function for determining a local loss between mask regions (e.g., the first mask region and the second mask region). In some embodiments, f(⋅) may include a mean square error (MSE) loss function, a mean absolute error (MAE) loss function, a structural similarity index (SSIM) loss function, or the like, or any combination thereof.

In some embodiments, the processing device 120B may segment a first coronary artery from the sample intermediate image (e.g., using a coronary artery extraction algorithm (or model)). The coronary artery extraction algorithm (or model) may include any types of coronary artery extraction algorithms such as a 2D coronary artery extraction algorithm (or model) for segmenting a coronary artery from a 2D image, a 3D coronary artery extraction algorithm (or model) for segmenting a coronary artery from a 3D image. The processing device 120B may segment a second coronary artery from the reference image (e.g., using the coronary artery extraction algorithm or model). The processing device 120B may determine the value of the dice related loss function based on the first coronary artery and the second coronary artery. The smaller the value of the dice related loss function is, the more the first coronary artery may overlap with the second coronary artery, and the higher accuracy of the segmentation of the first coronary artery may be. The larger the value of the local loss function is, the less the first coronary artery may overlap with the second coronary artery, and the lower accuracy of the segmentation of the first coronary artery may be. For example, the processing device 120B may determine the value of the dice related loss function according to Equation (3) as follows:

$${Loss}_{dice} = 1 - Dice ( F ( M ( x ) ) , F ( GS ) ) , \qquad ( 3 )$$

where F(⋅) denotes the coronary artery extraction algorithm, F(M(x)) denotes the first coronary artery, F(GS) denotes the second coronary artery, and Dice (⋅) denotes a dice loss function for determining a segmentation accuracy of the coronary artery (e.g., the first coronary artery). A value of the Dice (F(M(x)), F(GS)) may range from 0 to 1 (i.e., [0, 1]). In some embodiments, the processing device 120B may replace the dice loss function (i.e., Dice ( ) with a specific loss function in Equation (3) for determining the dice related loss function. The specific loss function may be similar to the dice loss function. Exemplary specific loss functions may include a sensitivity-specificity loss function, a IoU loss function, a Tversky loss function, a generalized dice loss, a Focal Tversky loss function, or the like, or any combination thereof.

In some embodiments, the processing device 120B may determine the value of the global loss function based on the sample intermediate image and the reference image. The larger the value of the global loss function is, the less similar the sample intermediate image may be to the reference image (i.e., the higher level of artifact that the sample intermediate image has may be), and the worse the correction effect of the updated motion correction model may be. The smaller the value of the local loss function is, the more similar the sample intermediate image may be to the reference image (i.e., the lower level of artifact that the sample intermediate image has may be), and the better the correction effect of the updated motion correction model may be. For example, the processing device 120B may determine the value of the global loss function according to Equation (4) as follows:

$${Loss}_{global} = g ( M ( x ) , GS ) , \qquad ( 4 )$$

where g(⋅) denotes a global loss function for determining a global loss between the sample intermediate image and the reference image. g(⋅) may include a mean square error (MSE) loss function, a mean absolute error (MAE) loss function, a structural similarity index (SSIM) loss function, or the like, or any combination thereof. g(⋅) may be the same as or different from f(⋅). For example, the processing device 120B may determine a first value of the global loss function using the MSE loss function. The processing device 120B may determine a second value of the global loss function using the MAE loss function. The processing device 120B may determine the value of the global loss function based on the first value and the second value (e.g., by determining an average of the first value and the second value, or a weighted sum of the first value and the second value).

In some embodiments, the processing device 120B may perform a preprocessing operation on values of the one or more loss functions before determining the value of the combined loss function. The processing device 120B may determine the value of the combined loss function based on the preprocessed values of the one or more loss functions (e.g., by a weighted sum of the preprocessed values according to the weights of the one or more loss functions). The preprocessing operation may be configured to adjust the values of the one or more loss functions to a same order of magnitude. For example, if the combined loss function includes the local loss function, the dice related loss function, and the global loss function, the processing device 120B may enlarge at least one of the value of the local loss function or the value of the dice related loss function, such that the preprocessed value of the local loss function, the preprocessed value of the dice related loss function, and the value of the global loss function are in a same order of magnitude. As another example, the processing device 120B may reduce the value of the global dice loss function and/or enlarge at least one of the value of the local loss function and the value of the dice related loss function, such that the preprocessed value of the local loss function, the preprocessed value of the dice related loss function, and the preprocessed value of the global loss function are in a same order of magnitude. Further, the processing device 120B may determine the value of the combined loss function by a weighted sum of the preprocessed value of the local loss function, the preprocessed value of the dice related loss function, and the preprocessed value of the global loss function. In some embodiments, before determining the value of the combined loss function, the processing device 120B may perform a normalization operation of the preprocessed value of the preprocessed value of the local loss function, the preprocessed value of the dice related loss function, and the preprocessed value of the global loss function.

In some embodiments, the plurality of iterations may be performed to update the parameter values of the preliminary model (or the updated preliminary model) until a termination condition is satisfied. The termination condition may provide an indication of whether the preliminary model (or the updated preliminary model) is sufficiently trained. The termination condition may relate to the loss function or an iteration count of the iterative process or training process. For example, the termination condition may be satisfied if the value of the loss function associated with the preliminary model (or the updated preliminary model) is minimal or smaller than a threshold (e.g., a constant). As another example, the termination condition may be satisfied if the value of the loss function converges. The convergence may be deemed to have occurred if the variation of the values of the loss function in two or more consecutive iterations is smaller than a threshold (e.g., a constant). As still another example, the termination condition may be satisfied when a specified number (or count) of iterations are performed in the training process.

It should be noted that, in response to a determination that the value of the loss function associated with the preliminary model (or the updated preliminary model) is equal to the threshold (e.g., the constant), the processing device 120B may either determine that the termination condition is satisfied or determine that the termination condition is not satisfied.

In response to determining that the termination condition is not satisfied, process 700 may proceed to operation 740. In 740, the processing device 120B (e.g., the second generating module 460) may update the updated preliminary model based on the value of the loss function.

In some embodiments, parameter values of the updated preliminary model may be adjusted and/or updated in order to decrease the value of the loss function to smaller than the threshold, and a new updated preliminary model may be generated. Accordingly, in the next iteration, another set of training samples may be input into the new updated preliminary model to train the new updated preliminary model as described above.

In response to determining that the termination condition is satisfied, process 700 may proceed to operation 750. In 750, the processing device 120B (e.g., the second generating module 460) may designate the updated preliminary model as a candidate motion correction model or the target motion correction model based on the value of the loss function. For example, parameter values of the updated preliminary model may be designated as parameter values of the candidate motion correction model or the target motion correction model.

It should be noted that the above description regarding the process 700 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the process 700 may be accomplished with one or more additional operations not described and/or without one or more of the operations discussed above. For example, the process 700 may include an additional operation for determining whether the termination condition is satisfied.

FIG. 8 is a flowchart illustrating an exemplary process for determining a combined loss function according to some embodiments of the present disclosure. In some embodiments, process 800 may be executed by the medical system 100. For example, the process 800 may be implemented as a set of instructions (e.g., an application) stored in a storage device (e.g., the storage device 130, the storage device 220, and/or the storage 390). In some embodiments, the processing device 120B (e.g., the processor 210 of the computing device 200, the CPU 340 of the mobile device 300, and/or one or more modules illustrated in FIG. 4B) may execute the set of instructions and may accordingly be directed to perform the process 800. The operations of the illustrated process presented below are intended to be illustrative. In some embodiments, the process 800 may be accomplished with one or more additional operations not described and/or without one or more of the operations discussed. Additionally, the order of the operations of process 800 illustrated in FIG. 8 and described below is not intended to be limiting. In some embodiments, one or more operations of process 800 may be performed to achieve at least part of operation 620 as described in connection with FIG. 6, and/or operation 730 as described in connection with FIG. 7.

In 810, the processing device 120B (e.g., the third obtaining module 440) may obtain a plurality of corrected images of an original image.

The original image refers to an image of a subject (or a portion thereof) that has motion artifact(s) to be corrected as described in operation 510 in FIG. 5. In some embodiments, the plurality of corrected images may have different degrees of motion artifacts with respect to the original image.

In some embodiments, the plurality of corrected images may be previously stored in a storage device (e.g., the storage device 130, the storage device 220, the storage 390, or an external storage device) disclosed elsewhere in the present disclosure. The processing device 120B may obtain (e.g., retrieve) the plurality of corrected images from the storage device. Alternatively, the processing device 120B may obtain (e.g., determine) the plurality of corrected images. For example, the processing device 120B may determine the plurality of corrected images by using a plurality of correction algorithms or models on the original image respectively. As another example, the processing device 120B may simulate the plurality of corrected images based on the original image. As a further example, the processing device 120B may simulate the plurality of corrected images based on a reference image corresponding to the original image (e.g., by adding different levels of artifacts to the reference image to obtain the plurality of corrected images).

In 820, the processing device 120B (e.g., the third obtaining module 440) may obtain a reference image corresponding to the original image.

The reference image refers to an image with substantial removal of the motion artifacts from the original image as described in operation 610 in FIG. 6. In some embodiments, the reference image may be previously stored in a storage device (e.g., the storage device 130, the storage device 220, the storage 390, or an external storage device) of the present disclosure. The processing device 120B may obtain (e.g., retrieve) the reference image from the storage device. Alternatively, the processing device 120B may generate the reference image based on the original image (e.g., using a traditional motion correction algorithm and/or an existing correction model).

In 830, the processing device 120B (e.g., the third obtaining module 440) may determine the combined correction function based on the plurality of corrected images and the reference image.

As described in connection with FIGS. 6 and 7, the combined loss function may include one or more loss functions each of which corresponds a specific weight. As used herein, the determination of the combined correction function refers to determining and/or adjusting the weights of the one or more loss functions.

In some embodiments, the processing device 120B may determine a reference rank result by ranking the plurality of corrected images (e.g., manually by a user, or by comparing with the reference image). The processing device 120B may obtain an initial loss function (e.g., with initial weights of the one or more loss functions of the combined loss function). The processing device 120B may determine an evaluated rank result by ranking, based on the initial loss function and the reference image, the plurality of corrected images. For example, for each of the plurality of corrected images, the processing device 120B may determine a value of the initial loss function based on the corrected image and the reference image, which is similar to the determination of the value of the combined loss function based on the sample intermediate image and the reference image as described in operation 730. Further, the processing device 120B may determine the combined loss function by adjusting the initial loss function (e.g., adjusting weights of the initial loss function) until an updated evaluated rank result substantially coincides with the reference rank result.

For example, the processing device 120B may determine whether the evaluated rank result coincides with the reference rank result. In response to determining that the evaluated rank result coincides with the reference rank result, the processing device 120B may designate the current weights of the initial loss function as the weights of the combined loss function. In response to determining that the evaluated rank result does not coincide with the reference rank result, the processing device 120B may update the weights of the initial loss function until the updated evaluated rank result substantially coincides with the reference rank result. The processing device 120B may then designate final updated initial weights as the weights of the combined loss function.

It should be noted that the above description regarding the process 800 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added in and/or omitted from the process 800. For example, operation 830 may include two sub-operations one of which is for ranking the plurality of corrected images and another one of which is for determining the combined loss function based on the reference rank result. As another example, the process 800 may include a storing operation for storing the determined combined loss function for subsequent processing.

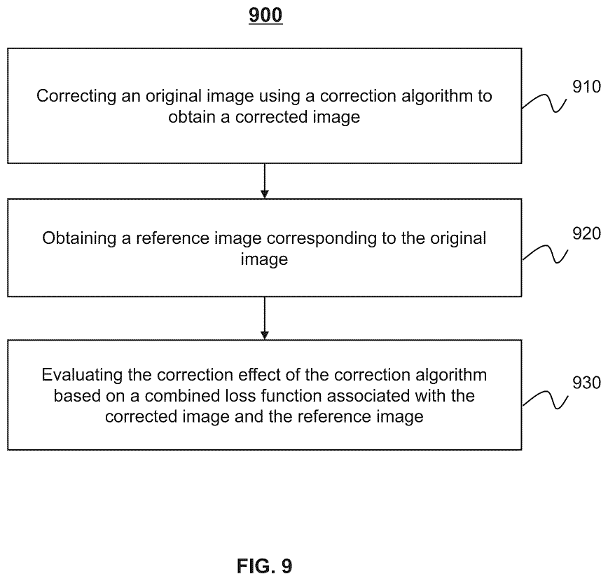

FIG. 9 is a flowchart illustrating an exemplary process for evaluating a correction effect of a correction algorithm according to some embodiments of the present disclosure. In some embodiments, process 900 may be executed by the medical system 100. For example, the process 900 may be implemented as a set of instructions (e.g., an application) stored in a storage device (e.g., the storage device 130, the storage device 220, and/or the storage 390). In some embodiments, the processing device 120B (e.g., the processor 210 of the computing device 200, the CPU 340 of the mobile device 300, and/or one or more modules illustrated in FIG. 4B) may execute the set of instructions and may accordingly be directed to perform the process 900. The operations of the illustrated process presented below are intended to be illustrative. In some embodiments, the process 900 may be accomplished with one or more additional operations not described and/or without one or more of the operations discussed. Additionally, the order of the operations of process 900 illustrated in FIG. 9 and described below is not intended to be limiting.

In 910, the processing device 120B (e.g., the third obtaining module 440) may correct an original image using the correction algorithm to obtain a corrected image.

As used herein, the original image may refer to an image of a subject (or a portion thereof) that has motion artifact(s) to be corrected. The subject (or a portion thereof) may undergo a motion during the acquisition of the original image using a medical device (e.g., the medical device 110). For example, the subject may include the heart of a patient (e.g., a left and/or right ventricle of the heart), a blood vessel of the patient (e.g., a left and/or right coronary artery), a lung of the patient, etc. Accordingly, the original image may include an image of the heart of a patient, an image of a lung of the patient, an image of a blood vessel of the patient, etc.

The correction algorithm may refer to an algorithm or model configured for motion correction of a medical image or raw data of the medical image. The correction algorithm may include any type of correction algorithm to be evaluated. Merely by way of example, the correction algorithm may include a motion vector field correction algorithm, a raw data correction algorithm, an artificial intelligence correction algorithm (e.g., a machine learning model for motion correction such as the target motion correction model described in FIGS. 5-8), or the like, or any combination thereof.

In 920, the processing device 120B (e.g., the third obtaining module 440) may obtain a reference image corresponding to the original image.

The reference image corresponding to the original image may be with substantial removal of the motion artifact(s) from the original image. For example, the reference image may have no motion artifact. As another example, a motion artifact in the reference image may be less than a preset level of artifact. In some embodiments, the processing device 120B may retrieve the reference image from one or more components of the medical system 100 or an external storage device of the medical system 100. Alternatively, the processing device 120B may generate the reference image by correcting the original image using a preset correction algorithm.

In 930, the processing device 120B (e.g., the third obtaining module 440) may evaluate the correction effect of the correction algorithm based on a combined loss function associated with the corrected image and the reference image.

As described in connection with FIGS. 6 and 7, the combined loss function may include one or more loss functions each of which corresponds to a specific weight. The one or more loss functions may include one or more local loss functions, a dice related loss function, a global loss function, or the like, or any combination thereof. For example, the combined loss function may include at least a local loss function associated with a first local region (e.g., a first mask region) of the corrected image and a second local region (e.g., a second mask region) of the reference image. The first local region and the second local region may be associated with a portion of the subject that has relatively obvious artifact(s) and/or a relatively large level of artifacts. For the corrected image associated with the heart of a patient, the first local region and the second local region may include a coronary artery.

In some embodiments, the processing device 120B may determine a value of the combined loss function based on values of the one or more loss functions. The processing device 120B may evaluate the correction effect of the correction algorithm based on the value of the combined loss function. For example, the smaller the value of the combined loss function is, the better the correction effect of the correction algorithm may be. Alternatively, the closer the value of the combined loss function to a preset value is, the better the correction effect of the correction algorithm may be. The preset value may be a default setting of the medical system 100 or adjustable according to different situations. In some embodiments, the processing device 120B may map the value of the combined loss function to an evaluation value. In some embodiments, different values of the combined loss function may correspond to different evaluation values. The processing device 120B may evaluate the correction effect of the correction algorithm according to the evaluation value. Alternatively, the processing device 120B may directly output the evaluation value for a user (e.g., a doctor), and the user may evaluate, based on the evaluation value according to a preset rule, the correction effect of the correction algorithm. For example, the preset rule may include that the smaller the value of the combined loss function is, the larger the evaluation value may be, and the better the correction effect of the correction algorithm may be.

In some embodiments, the combined loss function may include the local loss function associated with the first local region and the second local region, a dice related loss function associated with a first coronary artery of the corrected image and a second coronary artery of the reference image, and a global loss function associated with the corrected image and the reference image. The processing device 120B may determine the value of the combined loss function by a weighted sum of a value of the local loss function associated with the first local region and the second local region, a value of the dice related loss function associated with the first coronary artery and the second coronary artery, and a value of the global loss function. A first significance of the local loss function may be higher than a second significance of the dice related loss function. The second significance of the dice related loss function may be larger than a third significance of the global loss function. For instance, the processing device 120B may extract a centerline of the coronary artery from the reference image. The processing device 120B may determine a mask by performing an expansion operation on the centerline. The processing device 120B may determine the first local region of the corrected image based on the mask and the corrected image. The processing device 120B may determine the second local region of the reference image based on the mask and the reference image. The processing device 120B may determine the value of the local loss function based on a difference between the first local region and the second local region. As another example, the processing device 120B may segment the first coronary artery from the corrected image (e.g., using a coronary artery extraction algorithm or model). The processing 120B may segment the second coronary artery from the reference image. The processing device 120B may determine a value of the dice related loss function based on the first coronary artery and the second coronary artery. As still another example, the processing device 120B may determine the value of the global loss function based on the corrected image and the reference image. Further, the processing device 120B may determine the value of the combined loss function based on the value of the global loss function, the value of the dice related loss function, and the value of the global loss function. More descriptions regarding the determination of the combined loss function or the value thereof and/or the values of the one or more loss functions of the combined loss function may be found elsewhere in the present disclosure (e.g., operation 730 in FIG. 7 and the description thereof).

According to some embodiments of the present disclosure, the correction effect of the correction algorithm may be evaluated according to the combined loss function quantitatively, which improves the efficiency and accuracy of the evaluation of the correction effect.

In some embodiments, the processing device 120B may evaluate the correction effect of the correction algorithm based on the combined loss function and/or one or more additional loss functions. The additional loss function(s) may include a loss function whose value is positively related to the correction effect of the correction algorithm (i.e., the larger the value of the loss function is, the better the correction effect of the correction algorithm may be), such as a normalized circularity function, a positivity loss function, or a circularity loss function. The positivity loss function may be defined as Equation (5) as follows:

$${L}_{pos} = {\sum }_{{h}_{j} ∈ ROI} ( \{ \begin{matrix}0 , {h}_{j} > T \\ {( {h}_{j} - T )}^{2} , otherwise\end{matrix} ) , \qquad ( 5 )$$

where Lₚₒₛ denotes the positivity loss function, hⱼ denotes an intensity of jth pixel of a region of interest (ROI) (e.g., a vessel ROI such as a coronary artery) in the corrected image, and T denotes a threshold. The threshold may be defined as a myocardium intensity minus a standard deviarion of the myocardium to identify shading artifacts while reducing sensitivity to noise. The shading artifacts may be assumed to have lower intensity than the muocardium. The myocardium intensity may be determined as a mean value of pixels surrounding the coronary artery. The range of Lₚₒₛ may be [0, infinity). The larger a value of the positive loss function, the better the correction effect of the correction algorithm may be.

The circularity loss function may be defined as Equation (6) as follows:

$${L}_{circ} = \frac{4 π A}{{p}^{2}} , \qquad ( 6 )$$

where L_{circ} denotes the circularity loss function, p denotes a perimeter of a segmented vessel (e.g., a segmented coronary artery) of the corrected image, and A denotes an area of the segmented vessel. In some embodiments, the processing device 120b may segment the segmented vessel using a binary segmentation algorithm, and therefore the segmented vessel may also be referred to as a segmented binary vessel. The circularity of a perfect circle is equal to one, with non-circular shapes having circularity greater than one. Since A and p are measured on a pixelized image (e.g., the corrected image), a circularity value may be less than one in some cases due to discretization errors. The circularity values may be transformed to have a range of zero to one, with a value of zero indicating high deformation and a value of one indicating a perfect circle. Accordingly, a value of the circularity loss function may be [0, 1]. The larger the value of the circularity loss function is, the better the correction effect of the correction algorithm may be.

For example, the processing device 120B may evaluate the correction effect of the correction algorithm based on the value of the combined loss function and value(s) of the one or more additional loss functions. The smaller the value of the combined loss function is and the larger the value(s) of the one or more additional loss functions are, the better the correction effect of the correction algorithm may be.

It should be noted that the above description regarding the process 900 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added in and/or omitted from the process 900. For example, operation 930 may include two sub-operations one of which is for determining the value of the combined loss function and the other one of which is for evaluating the correction effect based on the value of the combined loss function. As another example, operation 910 may be omitted and the processing device 120B may obtain the corrected image from one or more components of the medical system 100 as disclosed in the present disclosure. In some embodiments, the processing device 120B may select an optimal correction algorithm from multiple correction algorithms based on combined loss functions corresponding to the multiple correction algorithms. For example, the processing device 120B may correct the original image using the multiple correction algorithms respectively to obtain multiple corrected images. For each of the multiple corrected images, the processing device 120B may determine a value of a combined loss function corresponding to one of the multiple correction algorithms based on the corrected image and the reference image. The processing device 120B may determine a minimum value of the combined loss function among the values of the multiple combined loss functions. The processing device 120B may determine a correction algorithm corresponding to a minimum value of the combined loss function as the optimal correction algorithm.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction performing system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A method for motion correction, which is implemented on a computing device including at least one processor and at least one storage device, comprising:
obtaining an original image including a motion artifact;
obtaining a target motion correction model; and
generating a target image by removing the motion artifact from the original image using the target motion correction model.

2. The method of claim 1, wherein the original image is a three-dimensional (3D) image including a plurality of 2D layers, and the generating a target image by removing the motion artifact from the original image using the target motion correction model comprises:
for each 2D layer of the plurality of 2D layers,
obtaining a plurality of reference layers adjacent to the 2D layer; and
generating a corrected 2D layer by inputting the 2D layer and the plurality of reference layers into the target motion correction model; and
generating the target image by combining a plurality of corrected 2D layers.

3. The method of claim 1, wherein the target motion correction model is obtained according to a process including:
obtaining a plurality of training samples each of which including a sample image and a reference image, wherein the sample image includes a motion artifact and the reference image is with substantial removal of the motion artifact; and
determining the target motion correction model by training, based on the plurality of training samples according to a combined loss function, a preliminary model, wherein the combined loss function includes at least a local loss function, a dice loss function, and a global loss function.

4. The method of claim 3, wherein the local loss function is associated with a coronary artery.

5. The method of claim 1, wherein the target motion correction model is obtained according to a process including:
obtaining a plurality of preliminary models of different structures;
obtaining a plurality of training samples, wherein the plurality of training samples includes at least one first training sample and at least one second training sample, and each training sample includes a first sample image and a first reference image; and
generating the target motion correction model by training each preliminary model of the plurality of preliminary models using the plurality of training samples.

6. The method of claim 5, wherein the obtaining a plurality of training samples comprises:
for each first training sample,
obtaining the first sample image including a motion artifact; and
obtaining the first reference image by removing the motion artifact from the first sample image.

7. The method of claim 5, wherein the obtaining a plurality of training samples comprises:
for each second training sample,
obtaining the first reference image without a motion artifact; and
obtaining the first sample image by adding a simulated motion artifact to the first reference image.

8. The method of claim 5, wherein the generating the target motion correction model by training each preliminary model of the plurality of preliminary models using the plurality of training samples comprises:
obtaining a plurality of candidate motion correction models by training the plurality of preliminary models using the plurality of training samples; and
selecting the target motion correction model from the plurality of candidate motion correction models based on a plurality of values of a first loss function corresponding to the plurality of candidate motion correction models.

9. The method of claim 8, wherein the obtaining a plurality of candidate motion correction models by training the plurality of preliminary models using the plurality of training samples comprises:
for the each preliminary model, training the preliminary model according to an iterative operation including one or more iterations, and in at least one of the one or more iterations, the method further comprises:
obtaining an updated preliminary model generated in a previous iteration;
for each training sample,
generating a first sample intermediate image by inputting the first sample image into the updated preliminary model;
determining a value of a second loss function based on the first sample intermediate image and the first reference image; and
updating the updated preliminary model based on the value of the second loss function, or
designating the updated preliminary model as a candidate motion correction model based on the value of the second loss function.

10. The method of claim 8, wherein the selecting the target motion correction model from the plurality of candidate motion correction models based on a plurality of values of a first loss function corresponding to the plurality of candidate motion correction models comprises:
obtaining at least one testing sample, wherein the at least one testing sample includes a second sample image and a second reference image;
for each candidate motion correction model,
generating a second sample intermediate image by inputting the second sample image into the candidate motion correction model; and
determining a value of the first loss function based on the second sample intermediate image and the second reference image; and
selecting the target motion correction model from the plurality of candidate motion correction models based on the plurality of values of the first loss function corresponding to the plurality of candidate motion correction models.

11. The method of claim 5, further comprising:
obtaining at least one verifying sample, wherein the at least one verifying sample includes a third sample image and a third reference image; and
verifying the target motion correction model using the at least one verifying sample.

12. The method of claim 11, wherein the verifying the target motion correction model using the at least one verifying sample comprises:
generating a third sample intermediate image by inputting the third sample image into the target motion correction model;
determining a value of a third loss function based on the third sample intermediate image and the third reference image; and
in response to determining that the value of the third loss function satisfies a condition, determining the target motion correction model as a verified target motion correction model.

13. The method of claim 1, wherein the original image is a computed tomography (CT) image of a heart.

14. A system for motion correction, comprising:
at least one storage device including a set of instructions; and
at least one processor configured to communicate with the at least one storage device, wherein when executing the set of instructions, the at least one processor is configured to direct the system to perform operations including:
obtaining an original image including a motion artifact;
obtaining a target motion correction model; and
generating a target image by removing the motion artifact from the original image using the target motion correction model.

15. The system of claim 14, wherein the original image is a three-dimensional (3D) image including a plurality of 2D layers, and the generating a target image by removing the motion artifact from the original image using the target motion correction model comprises:
for each 2D layer of the plurality of 2D layers,
obtaining a plurality of reference layers adjacent to the 2D layer; and
generating a corrected 2D layer by inputting the 2D layer and the plurality of reference layers into the target motion correction model; and
generating the target image by combining a plurality of corrected 2D layers.

16. The system of claim 14, wherein the target motion correction model is obtained according to a process including:
obtaining a plurality of training samples each of which including a sample image and a reference image, wherein the sample image includes a motion artifact and the reference image is with substantial removal of the motion artifact; and
determining the target motion correction model by training, based on the plurality of training samples according to a combined loss function, a preliminary model, wherein the combined loss function includes at least a local loss function, a dice loss function, and a global loss function.

17-27. (canceled)

28. A method for motion correction, which is implemented on a computing device including at least one processor and at least one storage device, comprising:
obtaining a plurality of preliminary models of different structures;
obtaining a plurality of training samples, wherein the plurality of training samples includes at least one first training sample and at least one second training sample, and each training sample includes a first sample image and a first reference image; and
generating a target motion correction model by training each preliminary model of the plurality of preliminary models using the plurality of training samples.

29. The method of claim 28, wherein the at least one first training sample is associated with at least one image generated by an imaging device, and the at least one second training sample is associated with at least one simulated image.

30. The method of claim 28, wherein the generating a target motion correction model by training each preliminary model of the plurality of preliminary models using the plurality of training samples comprises:
obtaining a plurality of candidate motion correction models by training the plurality of preliminary models using the plurality of training samples; and
selecting the target motion correction model from the plurality of candidate motion correction models based on a plurality of values of a first loss function corresponding to the plurality of candidate motion correction models.

31. The method of claim 30, wherein the obtaining a plurality of candidate motion correction models by training the plurality of preliminary models using the plurality of training samples comprises:
for the each preliminary model, training the preliminary model according to an iterative operation including one or more iterations, and in at least one of the one or more iterations, the method further comprises:
obtaining an updated preliminary model generated in a previous iteration;
for each training sample,
generating a first sample intermediate image by inputting the first sample image into the updated preliminary model;
determining a value of a second loss function based on the first sample intermediate image and the first reference image; and
updating the updated preliminary model based on the value of the second loss function, or
designating the updated preliminary model as a candidate motion correction model based on the value of the second loss function,
wherein the second loss function is a combined loss function including at least a local loss function, a dice loss function, and a global loss function.

32-62. (canceled)
